(19) United States
(12) Patent Application Publication
(10) Pub. No.: US 2023/0374285 A1
(43) Pub. Date: Nov. 23, 2023

(54) SPLIT-PROOF AUTOMOTIVE CORNER MOLDING COMPOUND

(71) Applicant: MCPP INNOVATION LLC, Tokyo (JP)

(72) Inventors: Divyanshu PATEL, Troy, MI (US); Nischay Kodihalli SHIVAPRAKASH, Sterling Heights, MI (US); Anthony Wayne COOKE, Chesterfield, MI (US); Sudhakar Muthanna HARAGA, Novi, MI (US)

(73) Assignee: MCPP INNOVATION LLC, Tokyo (JP)

(21) Appl. No.: 18/319,976

(22) Filed: May 18, 2023

Related U.S. Application Data
(60) Provisional application No. 63/343,278, filed on May 18, 2022.

(51) Int. Cl. C08L 23/16; C08K 3/16; C08K 3/34; C08K 5/14; B60J 10/15

(52) U.S. Cl. CPC C08L 23/16; C08K 3/16; C08K 3/34; C08K 5/14; B60J 10/15; C08K 2003/2296

(57) ABSTRACT

A composition for a thermoplastic vulcanizate is described. The composition may have an elastomer phase comprising both EPDM rubber and styrenic thermoplastic elastomer. The composition may comprise thermoplastic polyolefins including both a homopolymer of polypropylene and a random copolymer of polypropylene. A thermoplastic vulcanizate may be formed by dynamically vulcanizing the composition using peroxide or phenolic resin based crosslinking reactions. The produced thermoplastic vulcanizate may be formed into a corner molding compound showing durable mechanical properties and strong adhesion to a glass-run channel comprising a thermoplastic elastomer or a different thermoplastic vulcanizate.

### CROSS-REFERENCE TO RELATED APPLICATIONS

This application claims the benefit of priority from U.S. Provisional Application No. 63/343,278 filed May 18, 2022, the contents of which are incorporated herein by reference in their entirety.

### BACKGROUND

### Technical Field

The present invention relates to a composition for a thermoplastic vulcanizate that is particularly useful as an automotive corner molding compound.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Thermoplastic vulcanizates (“TPV”s) are formed from blends of crosslinked rubber and thermoplastic. Morphologically, TPVs are characterized by the presence of finely dispersed, micro-sized, rubber particles in a continuous thermoplastic matrix. The rubber phase is vulcanized with suitable curatives, typically by a dynamic vulcanization process, where the elastomeric component is selectively crosslinked during melt mixing with molten thermoplastics. Compared with conventional, non-vulcanized, thermoplastic elastomers (TPEs), TPV materials exhibit better properties, such as heat resistance, oil resistance, and elastic recovery. TPV materials have the benefits of the elastomeric properties provided by the elastomer phase and processability provided by the thermoplastic phase. TPVs have also gained wide acceptance as a replacement of both thermoset rubbers and flexible PVC (polyvinylchloride) in a variety of applications. TPVs may be used in the manufacture of a variety of products, and may be useful for making automotive interiors, such as instrument panels, floor consoles, and door panels.

Split is considered as a material failure which typically occurs at the interface between two materials due to lack of adhesion. In automotive applications, the split encountered at the interface between a glass-run channel (GRC) and a corner molding compound (CMC) at the door or window frame is known widely as the Lip Split. Another form of split which is found at the junction between the frame and the corner molding compound is called Frame Split. Both types of split are highly undesirable. To prevent splits occurring during service, a universal split test, also known as the creep test, was proposed for testing prototypes. The term “universal” refers to a TPE GRC extrusion compound comprising a wide range (wt %) of polypropylene (PP) bonded together with an injection molded CMC in a butt-joint fashion. The test served mainly two purposes: (1) predictive assessment of GRC and CMC butt-joint combinations that are most likely to display splits during service and (2) overall sturdiness rating of 1-10 with numbers indicating time in hours to failure of various butt-joint combinations (GRC and CMC) as measured by a creep test at 100° C. using a 370 g external load. A number 10 on the sturdiness rating indicates no break after 24 hours for the butt-joint combination (GRC and CMC) which would imply no split in service.

### BRIEF SUMMARY

The present invention particularly relates to a TPV used for a CMC. This TPV-CMC has exceptional adhesion to GRC profiles made of TPV, TPE, and vulcanized ethylene propylene diene monomer rubber (EPDM). The sturdiness rating as measured by a creep test at 100° C. using a load of 370 g or greater implies the time to failure of the various butt joints formed between the TPV-CMC and the GRC of TPV, TPE, or vulcanized EPDM. The TPV-CMCs described herein ensure no split due to the excellent adhesion to GRC profiles over a long duration and under extreme service conditions of testing. The TPV-CMCs also show excellent mechanical properties such as elastic recovery, elongation, modulus, and tensile strength. Even after aging at 125° C. for 1000 h, the TPV-CMC has at least 60% retention of mechanical properties (elongation, modulus and tensile strength). Besides mechanical properties, the TPV-CMC of the present invention also displays superior tribological properties, namely: coefficient of friction (COF) and scratch resistance. In view of the foregoing, one objective of the present invention is to provide a composition for a thermoplastic vulcanizate that shows improved adhesion and durability in automotive applications.

According to a first aspect, the present disclosure relates to a composition for a thermoplastic vulcanizate, comprising: 12-25 wt % ethylene propylene diene rubber (EPDM); 12-25 wt % styrenic thermoplastic elastomer; 8-30 wt % thermoplastic polyolefin; 0.01-3.0 wt % phenolic resin; 5-40 wt % process oil; 1-10 wt % slip additive; and 0.5-8 wt % inorganic filler; each weight percent relative to a total weight of the composition.

According to a second aspect, the present invention relates to a composition for a thermoplastic vulcanizate, comprising: 12-25 wt % EPDM; 12-25 wt % styrenic thermoplastic elastomer; 8-30 wt % thermoplastic polyolefin; 0.1-1.5 wt % peroxide crosslinking agent; 5-40 wt % process oil; 1-10 wt % slip additive; and 0.5-8 wt % inorganic filler; each weight percent relative to a total weight of the composition.

In one embodiment, the thermoplastic polyolefin is a polypropylene-based resin.

In one embodiment, the thermoplastic polyolefin comprises a random copolymer of polypropylene.

In a further embodiment, the random copolymer of polypropylene has a density in a range of 0.90-0.95 g/cm³.

In one embodiment, the composition further comprises 0.01-2.0 wt % stannous chloride and 0.1-1.0 wt % zinc oxide.

In one embodiment, the composition comprises 16-22 wt % of the styrenic thermoplastic elastomer.

In one embodiment, the slip additive comprises a polysiloxane having a weight average molecular weight of at least 700,000 g/mol.

In one embodiment, the inorganic filler comprises talc.

In one embodiment, the composition further comprises 0.5-10 wt % polyhedral oligomeric silsesquioxane.

In one embodiment, where a peroxide crosslinking agent is present, the peroxide crosslinking agent comprises at least one organic peroxide selected from the group consisting of di-tert-butyl peroxide, dicumyl peroxide, t-butylcumyl peroxide, α,α′-bis(tert-butylperoxy) diisopropyl benzene, 2,5-dimethyl-2,5-di-(tert-butylperoxy)hexane, 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, and 2,5-dimethyl-2,5-di(tert-butylperoxy) hexyne-3.

In a further embodiment, the peroxide crosslinking agent is 2,5-dimethyl-2,5-di-(tert-butylperoxy)hexane.

According to a third aspect, the present invention relates to a thermoplastic vulcanizate made by dynamically vulcanizing the composition of the first or second aspects.

In one embodiment, the thermoplastic vulcanizate has a crystallinity of less than 15% as measured by DSC.

In one embodiment, the thermoplastic vulcanizate, after aging at 100-150° C. for 750-1,250 hours has a tensile strength that is decreased by 16% or less as compared to a tensile strength before the aging.

In one embodiment, after aging at 100-125° C. for 750-1,000 hours, the thermoplastic vulcanizate has a tensile strength that is decreased by 16% or less as compared to a tensile strength before the aging.

In one embodiment, after aging at 100-125° C. for 750-1,000 hours, the thermoplastic vulcanizate has an elongation at break that is decreased by 25% or less as compared to an elongation at break before the aging.

In one embodiment, the thermoplastic vulcanizate has a static coefficient of friction in a range of 0.20-0.35 and a kinetic coefficient of friction in a range of 0.20-0.35.

In one embodiment, the thermoplastic vulcanizate has a static coefficient of friction in a range of 0.20-0.35 and a kinetic coefficient of friction in a range of 0.15-0.30.

According to a fourth aspect, the present invention relates to a corner molding compound, comprising the thermoplastic vulcanizate of the third aspect.

According to a fifth aspect, the present invention relates to an automotive assembly comprising the corner molding compound of the third aspect adhered to a glass-run channel, the glass-run channel comprising a second thermoplastic vulcanizate or a vulcanized EPDM at a joint

In one embodiment, an adhesion strength measured across the joint is in a range of 3.2-4.5 MPa.

In one embodiment, an adhesion strength measured across the joint is in a range of 3.2-4.1 MPa.

In one embodiment, an elongation at break measured across the joint is in a range of 120-275%.

In one embodiment, an elongation at break measured across the joint is in a range of 120-180%.

In one embodiment, the joint has a cross-section area of no greater than 50 mm² and is bent at an angle of 80-100°, and the joint does not break for at least 14 days at a temperature of at least 80° C. and under the strain of a weight of at least 300 g.

In a further embodiment, the joint does not break for at least 35 days.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B show the location and arrangement of a corner molding compound on an automobile window.

FIGS. 2A to 2C illustrate different assemblies between a corner molding compound and a glass-run channel.

FIG. 3A shows the viscosity (Pa·s) at 200° C. and a 204 s⁻¹ shear rate of exemplary TPV-CMC and a commercial TPV.

FIG. 3B shows the hardness (Shore A) of exemplary TPV-CMC and a commercial TPV.

FIG. 3C shows the density (g/cm³) of exemplary TPV-CMC and a commercial TPV.

FIG. 3D shows the tensile strength (MPa) of exemplary TPV-CMC and a commercial TPV.

FIG. 3E shows the modulus (MPa) of exemplary TPV-CMC and a commercial TPV.

FIG. 3F shows the elongation at break (%) of exemplary TPV-CMC and a commercial TPV.

FIG. 3G shows the tear strength (kN/m) of exemplary TPV-CMC and a commercial TPV.

FIG. 3H shows the compression set (%) at 70° C./22 h of exemplary TPV-CMC and a commercial TPV.

FIG. 4A shows the change in hardness (Shore A) of exemplary TPV-CMC and a commercial TPV (“competitor”) before and after aging for 1,000 h at 125° C.

FIG. 4B shows the change in modulus (MPa) of exemplary TPV-CMC and a commercial TPV (“competitor”) before and after aging for 1,000 h at 125° C.

FIG. 4C shows the change in tensile strength (MPa) of exemplary TPV-CMC and a commercial TPV (“competitor”) before and after aging for 1,000 h at 125° C.

FIG. 4D shows the change in elongation at break (%) of exemplary TPV-CMC and a commercial (“competitor”) TPV before and after aging for 1,000 h at 125° C.

FIG. 5A shows a first configuration of a TPV-CMC adhered to a GRC plaque for adhesion testing.

FIG. 5B shows where the adhesion testing sample is cut from FIG. 5A.

FIG. 6A shows a second configuration of a TPV-CMC adhered to a GRC plaque for adhesion testing.

FIG. 6B shows the dimensions of the second configuration of FIG. 6A.

FIG. 6C shows where the adhesion testing sample is cut from FIG. 6B.

FIG. 7A shows the adhesion strength (MPa) of exemplary TPV-CMC and a commercial TPV, each bonded to a PP/EPDM-based TPV plaque and made from the first configuration.

FIG. 7B shows the adhesion strength (MPa) of exemplary TPV-CMC and a commercial TPV, each bonded to a PP/EPDM-based TPV plaque and made from the second configuration.

FIG. 7C shows the elongation at break (%) of exemplary TPV-CMC and a commercial TPV, each bonded to a PP/EPDM-based TPV plaque and made from the first configuration.

FIG. 7D shows the elongation at break (%) of exemplary TPV-CMC and a commercial TPV, each bonded to a PP/EPDM-based TPV plaque and made from the second configuration.

FIG. 8A shows the adhesion strength (MPa) of exemplary TPV-CMC and a commercial TPV, each bonded to a Santoprene 101-64/TPV plaque.

FIG. 8B shows the adhesion strength (MPa) of exemplary TPV-CMC and a commercial TPV, each bonded to a Trexprene A67BW-LF/TPV plaque.

FIG. 9A shows the elongation at break (%) of exemplary TPV-CMC and a commercial TPV, each bonded to a Santoprene 101-64/TPV plaque.

FIG. 9B shows the elongation at break (%) of exemplary TPV-CMC and a commercial TPV, each bonded to a Trexprene A67BW-LF/TPV plaque.

FIG. 10 illustrates an experimental setup of a creep test.

FIG. 11A illustrates an experimental setup of a creep test at a 90° angle.

FIG. 11B is a photograph showing the experimental setup of FIG. 11A being used.

FIG. 12 is an illustration of a test apparatus used to measure static and kinetic coefficients of friction.

### DETAILED DESCRIPTION OF THE EMBODIMENTS

Embodiments of the present disclosure will now be described more fully hereinafter with reference to the accompanying drawings, in which some, but not all embodiments of the disclosure are shown.

Various terms as used herein are defined below. To the extent a term used in a claim is not defined below, it should be given the broadest definition persons in the pertinent art have given that term as reflected in one or more printed publications or issued patents.

As used herein, the words “a” and “an” and the like carry the meaning of “one or more” or “at least one.” Within the description of this disclosure, where a numerical limit or range is stated, the endpoints are included unless stated otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−0.5% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, “compound” is intended to refer to a chemical entity, whether as a solid, liquid, or gas, and whether in a crude mixture or isolated and purified.

As used herein, “composite” refers to a combination of two or more distinct constituent materials into one. The individual components, on an atomic level, remain separate and distinct within the finished structure. The materials may have different physical or chemical properties, that when combined, produce a material with characteristics different from the original components. In some embodiments, a composite may have at least two constituent materials that comprise the same empirical formula but are distinguished by different densities, crystal phases, or a lack of a crystal phase (i.e. an amorphous phase).

The present disclosure is intended to include all hydration states of a given compound or formula, unless otherwise noted or when heating a material. For example, SnCl₂ includes both anhydrous SnCl₂ and SnCl₂·2H₂O.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of carbon include ¹³C and ¹⁴C. Isotopes of nitrogen include ¹⁴N and ¹⁵N. Isotopes of oxygen include ¹⁶O, ¹⁷O, and 180. Isotopes of silicon include ⁸² Si, ²⁹Si, ³⁰Si, ³¹Si, and ³²Si. Isotopes of tin include ¹¹²Sn, ¹¹⁴Sn, ¹¹⁵Sn, ¹¹⁶Sn, ¹¹⁷Sn, ¹¹⁸Sn, ¹¹⁹Sn, ¹²⁰Sn, ¹²²Sn, ¹²⁴Sn, and ¹²⁶Sn. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

As used herein, a “polymer” may be used to refer to homopolymers, copolymers, interpolymers, terpolymers, etc. When a polymer is referred to as comprising a monomer, the monomer is present in the polymer in the polymerized form of the monomer or in the derivative form of the monomer. Thus, when a polymer is said to comprise a certain percentage (e.g., wt %) of a monomer, that percentage of monomer is based on the total amount of monomer units in all the polymer components of the composition or blend. That is, a polymer comprising 30 wt % ethylene and 70 wt % propylene is a polymer where 30 wt % of the polymer is ethylene-derived units and 70 wt % of the polymer is propylene-derived units.

As used herein and except as stated otherwise, the term “copolymer,” and grammatical variants thereof, refers to a polymer derived from two or more monomers (e.g., terpolymers, tetrapolymers, and the like).

A “thermoplastic” material is a linear or branched polymer which may be repeatedly softened and made flowable when heated and then returned to a hard state when cooled to room temperature. It generally has an elastic modulus greater than 10,000 psi in accordance with the method of ASTM D638. In addition, thermoplastics may be molded or extruded into articles of any predetermined shape when heated to the softened state.

An “elastomer” is a rubber-like polymer which may be stretched under tension to at least twice its original length and retracts rapidly to its original dimensions when the tensile force is released. An elastomer generally has an elastic modulus less than about 6,000 psi and an elongation generally greater than 200% in the uncrosslinked state at room temperature in accordance with the method of ASTM D412.

Thermoplastic elastomers (TPE) are a family of materials that have the properties of elastomers but may be processed like thermoplastics. When TPEs are made from polyolefins as described above, they are known in the industry as thermoplastic olefin elastomers (TPO). TPEs and TPOs are generally made by blending two or more polymers or by synthesizing block copolymers or graft copolymers. In each case the thermoplastic elastomer may comprise at least two segments, for instance, one being a rigid, usually semi-crystalline thermoplastic and the other being an amorphous elastomer.

The term “thermoplastic vulcanizate,” and grammatical variants thereof, including “thermoplastic vulcanizate composition,” “thermoplastic vulcanizate material,” or “TPV,” and the like, is broadly defined as any material that includes a dispersed, at least partially vulcanized, rubber component and a thermoplastic component (e.g., a thermoplastic polyolefin). A TPV material may further include other ingredients, other additives, or combinations thereof.

The term “vulcanizate,” and grammatical variants thereof, means a composition that includes some component (e.g., rubber) that has been vulcanized. The term “vulcanized,” refers in general to the state of a composition after all or a portion of the composition (e.g., a crosslinkable rubber) has been subjected to some degree or amount of vulcanization (crosslinking). Accordingly, the term encompasses both partial and total vulcanization. A preferred type of vulcanization is “dynamic vulcanization,” discussed below, which also produces a “vulcanizate.” Also, in at least one specific embodiment, the term vulcanized refers to more than insubstantial vulcanization (e.g., curing or crosslinking) that results in a measurable change in pertinent properties (e.g., a change in the melt flow index (MFI) of the composition by 10% or more, according to any ASTM- 1238 procedure). In at least one or more contexts, the term vulcanization encompasses any form of curing (or crosslinking), both thermal and chemical, that may be utilized in dynamic vulcanization.

The term “dynamic vulcanization,” and grammatical variants thereof, means vulcanization or curing of a curable rubber component blended with a thermoplastic component under conditions of shear at temperatures sufficient to plasticize the mixture. In at least one embodiment, the rubber component is simultaneously crosslinked and dispersed as micro-sized particles within the thermoplastic component. Depending on the degree of cure, the rubber component to thermoplastic component ratio, compatibility of the rubber component and thermoplastic component, the kneader type and the intensity of mixing (shear rate), other morphologies, such as co-continuous rubber phases in the plastic matrix, are possible.

As used herein, the “thermoplastic component,” and grammatical variants thereof, of the thermoplastic vulcanizates of the present disclosure refers to any material that is not a “rubber” and that is a polymer or polymer blend considered by persons skilled in the art as being thermoplastic in nature (e.g., a polymer that softens when exposed to heat and returns to its original condition when cooled to room temperature).

The term “partially vulcanized,” and grammatical variants thereof (e.g., “at least partially vulcanized”), with reference to a rubber component is one wherein more than about 5 wt % of the rubber component (e.g., crosslinkable rubber component) is extractable in boiling xylene, subsequent to vulcanization, preferably dynamic vulcanization (e.g., crosslinking of the rubber phase of the thermoplastic vulcanizate). For example, at least 5 wt % and less than 20 wt % or 30 wt % or 50 wt % of the rubber component may be extracted from the specimen of the thermoplastic vulcanizate in boiling xylene, encompassing any value and subset therebetween. The percentage of extractable rubber component may be determined by the technique set forth in U.S. Pat. No. 4,311,628, which is incorporated by reference in its entirety.

As used herein, a “fully vulcanized” rubber is one wherein less than 5 wt % of the crosslinkable rubber is extractable in boiling xylene, subsequent to vulcanization (preferably dynamic vulcanization), e.g., crosslinking of the rubber phase of the thermoplastic vulcanizate. For example, in a thermoplastic vulcanizate comprising a fully vulcanized rubber, less than 5 wt %, or less than 3 wt %, or less than 2 wt %, or less than 1 wt % of the crosslinkable rubber may be extractable from the specimen of the thermoplastic vulcanizate in boiling xylene.

The present disclosure relates to a composition for a TPV that comprises a crosslinking agent based on phenolic resin or on a peroxide. The composition for a TPV may be referred to as “the composition,” unless indicated otherwise. The composition is vulcanized or crosslinked to form a thermoplastic vulcanizate that may be used in automotive applications. The composition using a phenol resin crosslinking agent may comprise 12-25 wt % EPDM; 12-25 wt % styrenic thermoplastic elastomer; 8-30 wt % thermoplastic polyolefin; 0.01-3.0 wt % phenolic resin; 5-40 wt % process oil; 1-10 wt % slip additive; and 0.5-8 wt % inorganic filler; each weight percent relative to a total weight of the composition. The composition using a peroxide crosslinking agent may comprise 12-25 wt % EPDM; 12-25 wt % styrenic thermoplastic elastomer; 8-30 wt % thermoplastic polyolefin; 0.1-1.5 wt % peroxide crosslinking agent; 5-40 wt % process oil; 1-10 wt % slip additive; and 0.5-8 wt % inorganic filler; each weight percent relative to a total weight of the composition. These components are described as follows.

### Rubber/Elastomer

In one embodiment, the composition for the thermoplastic vulcanizate comprises one or more rubbers or elastomers. The term “rubber” and “rubber component” may be used interchangeably herein with the term “elastomer.” A rubber may be vulcanized so as to exhibit elastomeric properties.

In one embodiment, the composition for the thermoplastic vulcanizate may comprise one or more rubbers or elastomers at a combined weight percentage in a range of 15-60 wt %, 18-55 wt %, 20-50 wt %, 22-48 wt %, 24-45 wt %, 25-42 wt %, 30-40 wt %, or 30-35 wt %, relative to a total weight of the composition.

Exemplary rubbers for use in the composition for a TPV described herein may include unsaturated non-polar elastomers, such as monoolefin copolymer elastomers comprising non-polar elastomer copolymers of two or more monoolefins (for example, EP elastomers), which may be copolymerized with at least one polyene, usually a diene (for example, EPDM elastomers). EPDM (ethylene propylene diene elastomer) is a polymer of ethylene, propylene, and one or more non-conjugated diene(s). Suitable non-conjugated dienes include 5-ethylidene-2-norbomene (ENB); 1,4-hexadiene; 5-methylene-2-norbomene; 1,6-octadiene; 5-methyl-1,4-hexadiene; 3,7-di methyl-1,6-octadiene; 1,3-cyclopentadiene; 1,4-cyclohexadiene; dicyclopentadiene (DCPD); 5-vinyl-2-norbornene (VNB); divinyl benzene, and the like, or combinations thereof. Such elastomers have the ability to produce TPVs with a cure state generally in excess of about 95% while maintaining physical properties attributable to the crystalline or semi-crystalline polymer. EP elastomers and EPDM elastomers with intrinsic viscosity (η) measured in Decalin at 135° C. of between 0.1 to 10 dL/g are typically preferred.

In one embodiment, the rubber is an EPDM rubber that comprises diene-derived units derived from ENB. In one embodiment, the rubber has an ENB content in a range of 1-10 wt %, 2-9 wt %, 3-7 wt %, 3-5 wt %, or about 4.5 wt %, relative to a total weight of the rubber.

The rubber may comprise an elastomeric copolymer that comprises from about 20 to about 90 mol % ethylene-derived units. Preferably, these copolymers comprise from about 40 to about 85 mol %, or from about 50 to about 80 mol % ethylene-derived units.

Furthermore, where the copolymers comprise diene-derived units, the diene-derived units may be present in an amount from about 0.1 to about 5 mol %, or from about 0.1 to about 4 mol %, or from about 0.15 to about 2.5 mol %. The balance of the copolymer may generally be made up of units derived from alpha-olefin monomers, such as propylene-derived units. Accordingly, the copolymer may comprise from about 10 to about 80 mol %, or from about 15 to about 50 mol %, or from about 20 to about 40 mol % alpha-olefin derived units. The foregoing mole percentages (mol %) are based upon the total moles of the polymer.

In some embodiments, the rubber component of the TPV may include cyclic olefin copolymer elastomers known in the art. For example, high melting point cyclic olefin copolymer engineering resins may be used.

In some embodiments, the rubber component of the TPV may include elastomeric copolymers that have a weight average molecular weight (M_{W}) that is greater than about 200,000 g/mol, or greater than about 300,000 g/mol, or greater than about 400,000 g/mol, and may be less than about 1,000,000 g/mol, or less than about 700,000 g/mol. These copolymers preferably have a number average molecular weight (M_{N}) that is greater than about 70,000 g/mol, or from about 100,000 g/mol to about 350,000 g/mol, or from about 120,000 g/mol to about 300,000 g/mol, or from about 130,000 g/mol to about 250,000 g/mol. Elastomers, especially those in the high end of the molecular weight range, are often oil extended in the manufacturing process and may be directly processed as such.

In some embodiments, the rubber component of the TPV may include elastomeric copolymers that have a Mooney Viscosity ML [(1+4@125° C.)] of 10-250, 30-200, 40-150, 40-100, 45-60, 48-56, and an MST [(5+4)@200° C.] below about 150, where the Mooney Viscosity is that of the non-oil extended elastomer.

In one embodiment, the rubber may comprise a butyl elastomer. As used herein, the term “butyl elastomer” includes copolymers of an isoolefin and a conjugated diolefin, terpolymers of an isoolefin with or without a conjugated diolefin, divinyl aromatic monomers and the halogenated derivatives of such copolymers and terpolymers. The halogenated versions thereof are particularly useful, especially brominated butyl elastomer. Another suitable copolymer that may be used is a copolymer of a C₄₋₇ isomonoolefin and a para-alkylstyrene, and preferably halogenated derivatives thereof. The amount of halogen in the copolymer, predominantly in the para-alkylstyrene, is from 0.1 to 10 wt %. A preferred example is the brominated copolymer of isobutylene and para-methylstyrene.

In one embodiment, the rubber may also be natural rubber or synthetic homo- or copolymer of at least one conjugated diene with an aromatic monomer, such as styrene, or a polar monomer such as acrylonitrile or alkyl-substituted acrylonitrile monomer(s) having from 3 to 8 carbon atoms. Those rubbers are higher in unsaturation than EPDM elastomer or butyl elastomers. Those elastomers may optionally be partially hydrogenated to increase thermal and oxidative stability. Desirably those elastomers have at least 50 wt % repeat units from at least one conjugated diene monomer having from 4 to 8 carbon atoms. Other synthetic elastomers desirably include repeat units from monomers having unsaturated carboxylic acids, unsaturated dicarboxylic acids, unsaturated anhydrides of dicarboxylic acids, and include divinylbenzene, alkylacrylates, and other monomers having from 3 to 20 carbon atoms.

In one embodiment, the rubber comprises a synthetic elastomer that may be nonpolar or polar depending on the comonomers. Examples of synthetic elastomers include synthetic polyisoprene, polybutadiene elastomer, styrene-butadiene elastomer (SBR), butadiene-acrylonitrile elastomer, etc. Amine-functionalized, carboxy-functionalized or epoxy-functionalized synthetic elastomers may be used, and examples of these include maleated EPDM, and epoxy-functionalized natural elastomers.

In some embodiments, the rubber of the TPV is advantageously completely or fully vulcanized. In other embodiments, the rubber component is partially vulcanized.

In one embodiment, the rubber includes a process oil extension, wherein the rubber is present as a mixture with a process oil. The process oil in this use may be called an “extender oil,” and may help to mix the rubber with the other components of the TPV composition. The rubber may be considered dispersed in the process oil. Where the rubber includes a process oil extension, the process oil may be present at a weight percentage in a range of 5-80 wt %, 10-75 wt %, 15-70 wt %, 20-65 wt %, 25-60 wt %, 30-55 wt %, 40-55 wt %, 45-55 wt %, 48-52 wt %, 49-51 wt %, or about 50 wt % relative to a total weight of the process oil and the rubber.

In one embodiment, the rubber comprises EPDM. EPDM is an ethylene propylene diene rubber which is a terpolymer, synthetic rubber. EPDM belongs to the random copolymers with saturated polymer main chain framework and double bonds in the side chain, which may serve to crosslink the EPDM rubber in the rubber mixture by means of vulcanization system. The EPDM may be produced with metallocene or Ziegler-Natta catalysts based on vanadium compounds and aluminum alkyl chlorides.

In one embodiment, the TPV composition comprises EPDM at a weight percentage in a range of 10-30 wt %, 12-28 wt %, 12-25 wt %, 13-23 wt %, 14-21 wt %, 14-20 wt %, 14-19 wt %, 14-18 wt %, 14-17 wt %, 14-16 wt %, 15-20 wt %, or about 15 wt % or about 15.5 wt % relative to a total weight of the TPV composition, where the weight percentage of the EPDM does not include a process oil extension.

In one embodiment, the TPV composition comprises EPDM at a weight percentage in a range of 20-60 wt %, 24-56 wt %, 24-50 wt %, 26-46 wt %, 28-42 wt %, 28-40 wt %, 28-38 wt %, 28-36 wt %, 28-34 wt %, 28-32 wt %, or about 30 wt % or about 31 wt %

EPDM relative to a total weight of the TPV composition, where the weight percentage of the EPDM includes a process oil extension.

In one embodiment, the EPDM has an ethylene content in a range of 40-80 wt %, 42-75 wt %, 45-70 wt %, 50-65 wt %, 52-64 wt %, 53-62 wt %, 54-61 wt %, 55-60 wt %, 56-60 wt %, 57-60 wt %, 57-59 wt %, or about 58 wt % relative to a total mass of the EPDM. In one embodiment the EPDM has a specific gravity in a range of 0.80-1.00, 0.82-0.95, 0.84-0.93, 0.85-0.90, 0.86-0.90, 0.87-0.89, or about 0.88. In one embodiment, the EPDM has a molecular weight (number average molecular weight or weight average molecular weight) in a range of 100,000-3,000,000 g/mol, 120,000-2,500,000 g/mol, 130,000-2,000,000 g/mol, 150,000-1,500,000 g/mol, 170,000-1,200,000 g/mol, 190,000-1,000,000 g/mol, 200,000-900,000 g/mol, 200,000-800,000 g/mol, 200,000-700,000 g/mol, 250,000-600,000 g/mol, 300,000-550,000 g/mol, 350,000-500,000 g/mol, 355,000-450,000 g/mol, 360,000-425,000 g/mol, 365,000-410,000 g/mol, 370,000-400,000 g/mol, 370,000-390,000 g/mol, or 370,000-380,000 g/mol. In one embodiment, the EPDM has a polydispersity index (PDI) in a range of 1-300, 10-290, 50-280, 100-275, 150-270, 200-260, or 240-260.

In one embodiment, the rubber comprises a styrenic thermoplastic elastomer (styrenic TPE). The styrenic thermoplastic elastomer may include hydrogenated styrenic triblock copolymer elastomers, including but not limited to SEBS (styrene/ethylene-butylene/styrene), SEPS (styrene/ethylene-propylene/styrene), and SEEPS (styrene/ethylene-ethylene-propylene/styrene). Hydrogenated styrenic triblock copolymers may include crosslinkable styrenic blocks, which, in combination with the crosslinkable midblocks, may afford greater overall crosslinking of the vulcanized elastomer within the TPV. These elastomers may have a styrene content as low as about 10 wt % to as high as about 50 wt %, or from about 20 wt % to about 40 wt %, or from about 25 wt % to about 35 wt %. The M_{w} of the styrene component may be from about 7,000 to about 50,000 g/mol, and the M_{w} of the elastomeric component may be from about 30,000 to greater than 150,000 g/mol.

In one embodiment, the styrenic TPE has a Shore A hardness in a range of 20-35, or 25-30. In one embodiment, the styrenic TPE has a density of greater than 0.88 g/cm³, greater than 0.89 g/cm³, or greater than 0.90 g/cm³, and/or less than 1.00 g/cm³, less than 0.98 g/cm³, less than 0.96 g/cm³, less than 0.95 g/cm³, less than 0.94 g/cm³, less than 0.93 g/cm³, less than 0.92 g/cm³, or less than 0.91 g/cm³. In one embodiment, the styrenic TPE has a tensile strength in a range of 1-8 MPa, 2-7 MPa, 3-5 MPa, or 3.3-4 MPa. In one embodiment, the styrenic TPE has an elongation at break in a range of 300-1,000%, 400-900%, 500-850%, 550-800%, 600-780%, or 660-750%. In one embodiment, the styrenic TPE has a compression set at 70° C. in a range of 30-70%, 35-65%, 40-62%, 42-60%, or 45-59%. In one embodiment, the styrenic TPE comprises less than 60 wt %, less than 55 wt %, less than 50 wt %, less than 45 wt %, or less than 40 wt % styrene blocks, and/or more than 10 wt %, more than 15 wt %, more than 20 wt %, or more than 25 wt %, or more than 30 wt % styrene blocks, each relative to a total weight of the styrenic TPE.

In one embodiment, the composition for a TPV comprises a styrenic TPE at a weight percentage in a range of 10-30 wt %, 11-28 wt %, 12-25 wt %, 13-23 wt %, 14-21 wt %, 14-20 wt %, 14-19 wt %, 14-18 wt %, 15-17 wt %, 14-16 wt %, 16-20 wt %, 16-19 wt %, 16-18 wt %, or about 17 wt % relative to a total weight of the TPV composition. In one embodiment, the rubber comprises a styrenic thermoplastic elastomer, which is a saturated or hydrogenated styrenic block copolymer of SEBS.

Preferably the rubber of the TPV composition comprises both EPDM and a styrenic thermoplastic elastomer. In one embodiment, the TPV composition comprises a styrenic thermoplastic elastomer and EPDM at a styrenic TPE:EPDM weight ratio in a range of 0.80:1 to 1.35:1, 0.90:1 to 1.30:1, 0.95:1 to 1.25:1, 1.00:1 to 1.20:1, 1.05:1 to 1.15:1, or 1.08 to 1.10:1, where the weight of the EPDM does not include an oil extension.

### Thermoplastic Polyolefin

In one embodiment, the composition for the TPV comprises one or more thermoplastic polyolefins at a combined weight percentage in a range of 8-37 wt, 9-36 wt %, 10-35 wt %, 11-34 wt %, 12-33 wt %, 13-32 wt %, 14-31 wt %, 15-30 wt %, 16-30 wt %, 18-29 wt %, 20-28 wt %, 21-27 wt %, 22-26 wt %, or 23-26 wt %.

In one embodiment, the thermoplastic polyolefin is a polymer of alpha-olefins (or α-olefins). Alpha-olefins are a family of organic compounds which are alkenes (also known as olefins) with a chemical formula CₓH₂ₓ, distinguished by having a double bond at the primary or alpha (α) position.

In a further embodiment, the polymeric olefin is a polypropylene-based resin having a propylene unit content of 50-100 wt %, 60-100 wt % 70-100 wt %, 80-100 wt % or 90-100 wt % relative to a total weight of the polymeric olefin and may be a propylene homopolymer or a propylene-based copolymer. A propylene-based copolymer may comprise, in addition to a propylene unit, an α-olefin unit except for propylene (the “α-olefin” as used herein includes ethylene) or a monomer unit except for α-olefin, in an amount of 10 wt % or less, 8 wt % or less, 5 wt % or less, 4 wt % or less, 2 wt % or less, or 1 wt % or less. The α-olefin unit except for propylene includes ethylene and an α-olefin having a carbon number of 4 to 20. The α-olefin having a carbon number of 4 to 20 includes 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 4-methyl-1-pentene, 2-ethyl-1-hexene, 2,2,4-trimethyl-1-pentene, etc. As the α-olefin except for propylene, ethylene, and an α-olefin having a carbon number of 4 to 10 are preferred, and ethylene, 1-butene, 1-hexene, and 1-octene are more preferred. In one embodiment, the polymeric olefin is a polypropylene-based resin comprising 1-45 wt %, 2-40 wt %, 3-38 wt %, 4-35 wt %, 5-33 wt %, 6-32 wt %, 7-31 wt %, 8-30 wt %, 9-28 wt %, 10-25 wt %, 11-23 wt %, 12-21 wt %, 15-20 wt % ethylene relative to a total weight of the polymeric olefin.

The polypropylene-based resin includes, for example, a propylene homopolymer, a propylene-ethylene copolymer, a propylene- 1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer. A propylene homopolymer and a copolymer of propylene and at least one monomer selected from ethylene and an α-olefin having a carbon number of 4 to 10, 4 to 8, 4 to 6 are preferred. The polypropylene-based resin may be a polypropylene block copolymer, and among others, in view of low-temperature impact resistance and high-temperature strength, a polypropylene block copolymer obtained by polymerizing a propylene homopolymer in a first step and subsequently polymerizing a propylene-ethylene copolymer in a second step. In one embodiment, the polypropylene-based resin may be a random copolymer of polypropylene produced by polymerizing propene and ethene units together. In one embodiment, the propylene-based resin comprises an isotactic polypropylene, a syndiotactic polypropylene, and/or an atactic polypropylene.

In one embodiment, the one or more thermoplastic polyolefins has a weight average molecular weight (Mw) of about 50,000 g/mol to about 2,000,000 g/mol (such as about 100,000 g/mol to about 1,000,000 g/mol, such as about 100,000 g/mol to about 600,000 g/mol, such as about 400,000 g/mol to about 800,000 g/mol) and/or a number average molecular weight (MN) that is about 25,000 g/mol to about 1,000,000 g/mol (such as about 50,000 g/mol to about 300,000 g/mol) as measured by GPC with polystyrene standards.

In one embodiment, the thermoplastic polyolefin may be or may comprise a crystalline thermoplastic polyolefin that has a crystallinity of at least 25%, at least 28%, at least 30%, at least 35%, at least 40%, or at least 45%, at least 50%, or at least 55%. In one embodiment, the crystallinity may be in a range of 25-80%, 30-70%, 30-60%, 31-56%, 32-55%, 33-54%, 35-50%, 36-47%, 37-45%, or 38-42%. Crystallinity may be determined by dividing the heat of fusion (Hf) of a sample by the heat of fusion of a 100% crystalline polymer, which is assumed to be 209 J/g for polypropylene. A polymer may be considered semi-crystalline if it has a crystallinity of at least 25%. The crystalline thermoplastic polyolefin may have, independently, a melt flow rate (MFR) at 230° C./2.16 kg in a range of 0.1-70 g/10 min, 0.4-65 g/10 min, 0.4-62 g/10 min, 0.5-60 g/10 min, 1-70 g/10 min, 5-68 g/10 min, 10-67 g/10 min, 15-66 g/10 min, 20-65 g/10 min, 25-64 g/10 min, 30-63 g/10 min, 35-62 g/10 min, 40-61 g/10 min, 45-60 g/10 min, or 50-55 g/10 min and/or a heat of fusion in a range of 10-135 J/g, 15-134 J/g, 20-132 J/g, 25-131 J/g, 30-130 J/g, 35-130 J/g, 40-130 J/g, 45-128 J/g, 50-125 J/g, 55-122 J/g, 60-120 J/g, 66-115 J/g, 67-110 J/g, 69-107 J/g, 70-105 J/g, 71-102 J/g, 72-100 J/g, 73-95 J/g, 73-90 J/g, 73-85 J/g, or 73-80 J/g.

In one embodiment, the crystalline thermoplastic polyolefin is a homo-polypropylene (Homo PP) and/or a random copolymer of polypropylene (RACO PP).

In one embodiment, the thermoplastic polyolefin comprises at least one homo-polypropylene and a random copolymer of polypropylene. In one embodiment, the random copolymer of polypropylene may have, independently, a melt flow rate (MFR) at 230° C./2.16 kg in a range of 35-80 g/10 min, 40-75 g/10 min, 50-70 g/10 min, 0.1-70 g/10 min, 0.4-65 g/10 min, 0.4-62 g/10 min, 0.5-60 g/10 min, 1-70 g/10 min, 5-68 g/10 min, 10-67 g/10 min, 15-66 g/10 min, 20-65 g/10 min, 25-64 g/10 min, 30-63 g/10 min, 35-62 g/10 min, 40-61 g/10 min, 45-60 g/10 min, or 50-55 g/10 min and/or a heat of fusion in a range of 50-90 J/g, 55-85 J/g, 60-80 J/g, 10-135 J/g, 15-134 J/g, 20-132 J/g, 25-131 J/g, 30-130 J/g, 35-130 J/g, 40-130 J/g, 45-128 J/g, 50-125 J/g, 55-122 J/g, 60-120 J/g, 66-115 J/g, 67-110 J/g, 69-107 J/g, 70-105 J/g, 71-102 J/g, 72-100 J/g, 73-95 J/g, 73-90 J/g, 73-85 J/g, or 73-80 J/g. In one embodiment, the random copolymer of polypropylene has a crystallinity in a range of 0-40%, 10-38%, 15-36%, 25-80%, 30-70%, 30-60%, 31-56%, 32-55%, 33-54%, 35-50%, 36-47%, 37-45%, or 38-42%. In one embodiment, the random copolymer of polypropylene has a density of greater than 0.88 g/cm³, greater than 0.89 g/cm³, or greater than 0.90 g/cm³, and/or less than 1.00 g/cm³, less than 0.98 g/cm³, less than 0.96 g/cm³, less than 0.95 g/cm³, less than 0.94 g/cm³, less than 0.93 g/cm³, less than 0.92 g/cm³, or less than 0.91 g/cm³. In one embodiment, the random copolymer of polypropylene is Lumicene® MR60MC2 polypropylene random copolymer from Total. In another embodiment, the composition for a TPV does not comprise a random copolymer of polypropylene.

In one embodiment, the thermoplastic polyolefin may comprise crystalline thermoplastic polyolefins that include at least one homo-polypropylene and a random copolymer of polypropylene. Here, the at least one homo-polypropylene may be present in the composition at a combined weight percentage in range of 5-30 wt %, 6-27 wt %, 7-26 wt %, 8-25 wt %, 9-24 wt %, 9-23 wt %, 9-22 wt %, 9-21 wt %, 10-20 wt %, 11-19 wt %, 12-18 wt %, or 13-17 wt % relative to a total weight of the composition. The random copolymer of polypropylene may be present in the composition at a weight percentage in a range of 5-30 wt %, 6-29 wt %, 8-28 wt %, 9-27 wt %, 10-26 wt %, 11-25 wt %, 12-24 wt %, 13-22 wt %, 14-21 wt %, 15-20 wt %, 16-19 wt %, or 17-18 wt %, or about 10 wt %, about 12 wt %, about 15 wt %, about 16.5 wt %, about 18 wt %, or about 20 wt % relative to a total weight of the composition.

In one embodiment, the thermoplastic polyolefin comprises a random copolymer of polypropylene (or a total weight of more than one random copolymers of polypropylene) at a concentration of 30-80 wt %, 35-75 wt %, 37-72 wt %, 38-71 wt %, 39-70 wt %, 40-69 wt %, 41-68 wt %, 42-67 wt %, 43-66 wt %, 44-65 wt %, 45-64 wt %, 46-63 wt %, 47-62 wt %, 48-61 wt %, 49-60 wt %, 50-59 wt %, 51-58 wt %, 52-57 wt %, 53-56 wt %, 54-55 wt %, relative to a total weight of the thermoplastic polyolefin.

In one embodiment, the thermoplastic polyolefin comprises at least one homo-polypropylene at a combined concentration in a range of 20-70 wt %, 25-65 wt %, 28-63 wt %, 29-62 wt %, 30-61 wt %, 31-60 wt %, 33-58 wt %, 34-57 wt %, 35-56 wt %, 36-55 wt %, 37-54 wt %, 38-53 wt %, 39-52 wt %, 40-51 wt %, 41-50 wt %, 42-49 wt %, 43-48 wt %, 44-47 wt %, or 45-46 wt %, relative to a total weight of the thermoplastic polyolefin.

In one embodiment, the composition for a TPV does not comprise a high melt strength (HMS) polyolefin and/or an amorphous thermoplastic polyolefin. An HMS-PP has a higher degree of branching and/or long chain branching as compared to a polypropylene that is not an HMS-PP. In one embodiment, the composition for a TPV does not comprise a high melt strength polypropylene (HMS-PP). In another embodiment, the composition for a TPV does not comprise a polypropylene that has long chain branching.

A polypropylene is an HMS-PP if it has at least one of the four characteristics: a melt strength of at least 0.5 N, a gel index of less than 1,500, a gel content of 3% or less, or a branching index of less than 0.9.

Alternatively, the melt strength may be at least 0.7 N, at least 0.9 N, or at least 1.1 N; the gel index may be less than 1,300, less than 1,200, or less than 1,000; the gel content may be 2 wt % or less, 1 wt % or less, or 0.5 wt % or less; and/or the branching index may be less than 0.85, less than 0.8, less than 0.75, or less than 0.7

In one embodiment, the composition for a TPV only comprises thermoplastic polyolefins that have a branching index of at least 0.9, at least 0.95, at least 0.97, at least 0.98, at least 0.99, or 1. The branching index may be determined, for example, by the procedure disclosed in WO2020231526A1, incorporated herein by reference in its entirety. An RMS-PP may be produced from a linear PP by incorporating branches as a post reactor-treatment, or may be produced from in situ polymerization. A post reactor-treatment may involve electron beam irradiation or curing with a crosslinker.

### Crosslinking Agent

To enable vulcanization, the composition for a thermoplastic vulcanizate further comprises one or more crosslinking agents, which may also be called a curative agent, a curative, a coupling agent, or a curing system. The composition may comprise the one or more crosslinking agents at an individual or combined weight percentage in a range of 0.01-3.0 wt %, 0.05-3.0 wt %, 0.08-2.8 wt %, 0.1-2.5 wt %, 0.2-2.4 wt %, 0.3-2.3 wt % 0.4-2.2 wt %, 15 0.5-2.0 wt %, 0.6-1.9 wt %, 0.3-1.8 wt %, 0.3-1.7 wt %, 0.3-1.6 wt %, 0.3-1.5 wt %, 0.3-1.4 wt %, 0.3-1.3 wt %, 0.3-1.2 wt %, 0.3-1.1 wt %, 0.3-1.0 wt %, 0.3-0.9 wt %, or 0.3-0.8 wt %, relative to a total weight of the composition. In one embodiment, these weight percentages do not include process oil added to disperse the curatives (for instance, the weight of a paraffin oil used to disperse a phenolic resin-in-oil is not counted in the weight percentage).

In one embodiment, the one or more crosslinking agents may comprise a phenolic resin curative, a peroxide curative, a maleimide curative, a silicon-based curative (including hydrosilylation curative, a silane-based curative such as a silane grafting followed by moisture cure), a hexamethylene diamine carbamate curative, a sulfur curative, or any combination thereof.

In one embodiment, the TPV is cured using a phenolic resin vulcanizing agent. The preferred phenolic resin curatives may be referred to as resole resins, which are made by the condensation of alkyl substituted phenols or unsubstituted phenols with aldehydes, preferably formaldehydes, in an alkaline medium or by condensation of bi-functional phenoldialcohols. The alkyl substituents of the alkyl substituted phenols may contain 1 to about 10 carbon atoms. Dimethylolphenols or phenolic resins, substituted in para-positions with alkyl groups containing 1 to about 10 carbon atoms are preferred. In some embodiments, a blend of octyl phenol and nonylphenol-formaldehyde resins are employed. The blend may include from about 25 wt % to about 40 wt % octyl phenol, and from about 60 wt % to about 75 wt % nonylphenol, more preferably, the blend includes from about 30 wt % to about 35 wt % octyl phenol and from about 65 wt % to about 70 wt % nonylphenol. In some embodiments, the blend includes about 33 wt % octylphenol-formaldehyde and about 67 wt % nonylphenol formaldehyde resin, where each of the octylphenol and nonylphenol include methylol groups. This blend can be solubilized in paraffinic oil at about 30% solids.

Useful phenolic resins may be obtained under the tradenames SP-1044, SP-1045 (Schenectady International; Schenectady, NY), which may be referred to as alkylphenol-formaldehyde resins (also available in a 30/70 weight percent paraffinic oil solution under the trade name HRJ-14247A). SP-1045 is believed to be an octylphenol-formaldehyde resin that contains methylol groups. The SP-1044 and SP-1045 resins are believed to be essentially free of halogen substituents or residual halogen compounds. By “essentially free of halogen substituents,” it is meant that the synthesis of the resin provides for a non-halogenated resin that may only contain trace amounts of halogen containing compounds. In one embodiment, the crosslinking agent is a phenol formaldehyde resole resin.

The curative, such as a phenolic resin, may be introduced into the vulcanization process in a solution or as part of a dispersion. In preferred embodiments, the curative is introduced to the vulcanization process in an oil dispersion/solution, such as a curative-in-oil or a phenolic resin-in-oil, where the curative/resin is dispersed and/or dissolved in a process oil. The process oil used may be a mineral oil, such as an aromatic mineral oil, naphthenic mineral oil, paraffinic mineral oils, or combination thereof. In preferred embodiments, the process oil used is a low aromatic/sulfur content oil having an aromatic content of less than 5 wt %, or less than 3.5 wt %, or less than 1.5 wt % , or less than 1.0 wt %, or less than 0.5 wt %, and/or a sulfur content of less than 0.03 wt %, or less than 0.003 wt %, based on the weight of the oil.

The method of dispersing and/or dissolving the curative, such as a phenolic resin, in the process oil may be any method known in the art. For example, in some embodiments, the phenolic resin and process oil, such as a mineral oil and/or a low aromatic/sulfur content oil, may be fed together into a glass container equipped with a stirrer heated while stirring on a water bath of 60 to 100° C. for 1 to 10 hours, as described in U.S. Patent Application Publication US2013/0046049A1, incorporated herein by reference in its entirety. In other embodiments, the resin-in-oil dispersion may be made as part of the process for producing the phenolic resin, where the oil is a diluent in the manufacturing process.

In one embodiment, the phenolic resin curative is supplied as a solution in a process oil. Here, the phenolic resin curative may be present at a weight percentage in a range of 10-60 wt %, 15-50 wt %, 20-40 wt %, 25-35 wt %, or about 30 wt % relative to a total weight of the phenolic resin curative and the process oil.

In one embodiment, phenolic resin curative may be used in combination with a cure accelerator, a metal oxide, an acid scavenger, and/or polymer stabilizers. Useful cure accelerators include metal halides, such as stannous chloride, stannous chloride anhydride, stannous chloride dihydrate, and ferric chloride. The cure accelerator may be used to increase the degree of vulcanization of the TPV, and in some embodiments may be added in an amount of less than 1 wt % based on the total weight of the TPV. In preferred embodiments, the cure accelerator comprises stannous chloride. In some embodiments, the cure accelerator is introduced into the vulcanization process as part of a masterbatch. In one embodiment, the composition comprises zinc oxide at a weight percentage in a range of 0.1-1.0 wt %, 0.2-0.9 wt %, 0.3-0.8 wt %, 0.4-0.6 wt %, or about 0.5 wt %, relative to a total weight of the composition. In one embodiment, nanoparticles or microparticles of zinc oxide are used. The zinc oxide may have a surface area per mass in a range of 5-20 m²/g, 7-15 m²/g, 7-12 m²/g, 7-10 m²/g, or 8-9 m²/g.

In a related embodiment, for use with a phenolic resin curative, the composition comprises stannous chloride at a weight percentage in a range of 0.05-1.0 wt %, 0.08-0.8 wt %, 0.09-0.6 wt %, 0.10-0.5 wt %, 0.15-0.5 wt %, 0.15-0.3 wt %, or about 0.2 wt %, relative to a total weight of the composition.

In a related embodiment, for use with a phenolic resin curative, the composition comprises stearic acid at a weight percentage in a range of 0.01-1.00 wt %, 0.02-0.80 wt %, 0.05-0.60 wt %, 0.08-0.50 wt %, 0.09-0.25 wt %, 0.09-0.15 wt %, or about 0.10 wt % relative to a total weight of the composition.

In one embodiment the crosslinking agent may comprise a peroxide, and may further be considered an activator. Useful peroxide crosslinking agents include organic peroxides. Examples of organic peroxides include di-tert-butyl peroxide, dicumyl peroxide, t-butylcumyl peroxide, α,α′-bis(tert-butylperoxy) diisopropyl benzene, 2,5-dimethyl-2,5-di-(tert-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert- butylperoxy) hexyne-3, and the like, and any combination thereof. Also, diaryl eroxides, ketone peroxides, peroxydicarbonates, peroxyesters, dialkyl peroxides, hydroperoxides, peroxyketals, and the like, and any combination thereof may be used. Useful peroxides and their methods of use in dynamic vulcanization of thermoplastic vulcanizates are disclosed in U.S. Pat. No. 5,656,693, incorporated herein by reference in its entirety. In one embodiment, the crosslinking agent is or comprises a peroxide, and the peroxide is 2,5-dimethyl-2,5-di-(tert-butylperoxy)hexane (DBPH). The peroxide crosslinking agent may be present in the composition at a weight percentage in a range of 0.01-1.00 wt %, 0.02-0.80 wt %, 0.05-0.60 wt %, 0.08-0.50 wt %, 0.09-0.25 wt %, 0.09-0.15 wt %, or about 0.10 wt % relative to a total weight of the composition. The peroxide may be diluted in a process oil, such as a low aromatic/sulfur content oil.

In one embodiment, the peroxide crosslinking agent may be dispersed in a polyolefin, for instance, at a weight percentage in a range of 5-50 wt %, 10-40 wt %, 12-35 wt %, 15-30 wt %, 15-25 wt %, 18-22 wt %, or about 20 wt % relative to a total combined weight of the peroxide crosslinking agent and the dispersing polyolefin. In one embodiment, the dispersing polyolefin is polypropylene. In one embodiment, the peroxide crosslinking agent is dispersed in a polyolefin, and the crosslinking agent and the polyolefin have a combined weight percentage in the composition for a TPV in a range of 0.01-1.00 wt %, 0.02-0.80 wt %, 0.05-0.60 wt %, 0.08-0.50 wt %, 0.09-0.25 wt %, 0.09-0.15 wt %, or about 0.10 wt % relative to a total weight of the composition for a TPV.

A peroxide curative may be employed in conjunction with a co-agent, which also may be called a promoter. A co-agent may include a multi-functional acrylate ester, a multi-functional methacrylate ester, or combination thereof. In other words, the coagents include two or more organic acrylate or methacrylate substituents. Examples of co-agents include trimethylolpropane trimethacrylate (TMPTMA), triallylcyanurate, triallyl isocyanurate, triallyl phosphate, sulfur, N-phenyl bis-maleamide, zinc diacrylate, zinc dimethacrylate, divinyl benzene, 1,2-poly butadiene, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone di-oxime.

Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof.

Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof In one embodiment, the co-agent is TMPTMA. In order to maximize the efficiency of peroxide and co-agent crosslinking, the mixing and dynamic vulcanization may be carried out in a nitrogen atmosphere. In one embodiment, a co-agent for a peroxide curative may be present in the composition at a weight percentage in a range of 0.05-1.0 wt %, 0.1-0.8 wt %, 0.2-0.6 wt %, 0.2-0.5 wt %, or about 0.3 wt %, relative to a total weight of the composition. In one embodiment, an organic peroxide and a co-agent may both be present in the composition as a peroxide crosslinking agent, at a combined weight percentage in a range of 0.1-1.5 wt %, 0.1-1.2 wt %, 0.2-1.0 wt %, 0.3-0.8 wt, 0.3-0.7 wt %, 0.3-0.6 wt %, 0.3-0.4 wt %, or about 0.4 wt %, relative to a total weight of the composition for a TPV.

In one embodiment, the crosslinking agent may comprise silicon. The silicon may be in the form of a silicone or a polysiloxane. A silicon-containing crosslinking agent may include silicon hydride compounds having at least two Si—H groups. Silicon hydride compounds include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and combinations thereof.

In a related embodiment, the crosslinking agent is a silane compound having at least two different kinds of reactive groups of a hydrolyzable group (for example, an alkoxy group such as a methoxy group, an ethoxy group and the like; an acyloxy group such as an acetoxy group and the like; a halogen group such as a chloro group and the like) and an organic functional group (for example, an amino group, a vinyl group, an epoxy group, a methacryloxy group, an acryloxy group, an isocyanate group and the like).

Examples of the component include a vinyl-based silane crosslinking agent (a silane compound having a vinyl group and a hydrolyzable group), a methacrylic-based silane crosslinking agent (a silane compound having a methacryloxy group and a hydrolyzable group), an acrylic-based silane crosslinking agent (a silane compound having an acryloxy group and a hydrolyzable group), an epoxy-based silane crosslinking agent (a silane compound having an epoxy group and a hydrolyzable group), an amino-based silane crosslinking agent (a silane compound having an amino group and a hydrolyzable group), a mercapto-based silane crosslinking agent (a silane compound having a mercapto group and a hydrolyzable group) and the like. Examples of a vinyl-based silane coupling agent include vinyltrimethoxysilane, vinyltriethoxysilane, vinyl tris(β-methoxyethoxy) silane, vinyltriacetoxysilane, vinyl-tris(n-butoxy) silane, vinyl-tris(n-pentoxy) silane, vinyl-tris(n-hexoxy) silane, vinyl-tris(n-heptoxy) silane, vinyl-tris(n-octoxy) silane, vinyl-tris(n-dodecyl oxo)silane, vinyl-bis(n-butoxy) methylsilane, vinyl-bis(n-pentoxy) methyl silane, vinyl-bis(n-hexoxy) methylsilane, vinyl-(n-butoxy) dimethylsilane, vinyl-(n-pentoxy) dimethylsilane, and combinations thereof.

### Slip Additive

In one embodiment, the composition for a TPV may include one or more slip additives or slip agents when the crosslinked rubber is cured with a phenolic or peroxide based cure system. One or more slip additives may be present in the composition at an individual or combined weight percentage in a range of 0.5-10 wt %, 0.6-9 wt %, 0.8-8 wt %, 1-7 wt %, 1.2-6 wt %, 1.5-5 wt %, 2-5 wt %, 3-8 wt %, 4-8 wt %, or about 2 wt % or about 5 wt %, relative to a total weight of the composition. A slip additive may reduce the coefficient of friction of the TPV composition while also improving abrasion resistance. Examples of slip additives include siloxane based additives (such as polysiloxanes), ultra-high molecular weight polyethylene, a blend of siloxane based additives (such as polysiloxanes) and ultra-high molecular weight polyethylene, molybdenum disulfide molybdenum disulfide, halogenated and unhalogenated compounds based on aliphatic fatty chains, fluorinated polymers (such as PVDF or PTFE), perfluorinated polymers, graphite, and combinations thereof. The slip additives are selected with a molecular weight suitable for the use in oil, paste, or powder form. In some embodiments, the slip additives may be of a migratory or non-migratory type.

In one embodiment, the slip additive may comprise a polysiloxane, preferably an ultra-high molecular weight siloxane (UHMW), and may have a weight average molecular weight in a range of 500,000-2,000,000 g/mol, 550,000-1,500,000 g/mol, 600,000-1,250,000 g/mol, 650,000-1,000,000 g/mol, 700,000-800,000 g/mol, 700,000-750,000 g/mol, or about 710,000 g/mol. The polysiloxane may have a number average molecular weight in a range of 10,000-50,000 g/mol, 15,000-40,000 g/mol, 20,000-35,000 g/mol, 25,000-32,000 g/mol, 27,000-30,000 g/mol, or about 29,000 g/mol. The polysiloxane may have a polydispersity index (PDT) in a range of 1-40, 10-35, 20-30, 22-26, or about 24. In one embodiment, the siloxane may be linear polydimethyl-siloxane (PDMS). In one embodiment, the slip additive has a kinetic or kinematic viscosity in a range of 500-80,000 cSt, 1,000-79,000 cSt, 3,000-78,000 cSt, 5,000-76,000 cSt, 10,000-75,000 cSt, 20,000-70,000 cSt, 40,000-65,000 cSt, 50,000-62,000 cSt, 55,000-61,000 cSt, or about 60,000 cSt. In one embodiment, the composition for a TPV comprises a siloxane or polysiloxane at a weight percentage in a range of 2-10 wt %, 3-9 wt %, or 4-8 wt % relative to a total weight of the composition.

In some embodiments a polysiloxane is bonded to or dispersed in a thermoplastic material. The thermoplastic material may be any homopolymer or copolymer of ethylene and/or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. In one embodiment, the thermoplastic material is a polypropylene homopolymer. Suitable methods of bonding a polysiloxane to an organic thermoplastic polymer, such as a polyolefin, are disclosed in International Patent Publication Nos. WO2015132190 and WO2015150218, incorporated herein by reference in their entirety. In one embodiment, the slip additive comprises a polysiloxane melt blended with a polypropylene homopolymer, where the polysiloxane is present at a weight percentage in a range of 10-90 wt %, 20-80 wt %, 30-70 wt %, 40-60 wt %, 45-55 wt %, or about 50 wt %, relative to a combined weight of the polysiloxane and the polypropylene homopolymer. In one embodiment where the polysiloxane melt is blended with a thermoplastic material, the thermoplastic material has a melt flow rate (MFR) at 230° C./2.16 kg in a range of 5-20, 8-18, 10-16, 11-15, or about 12. In one embodiment, the slip additive is XIAMETER® PMX-200 Silicone Fluid or HMB-0221, each available from Dow, or GENIOPLAST® PP50S12 available from Wacker.

In one embodiment the polysiloxane also comprises R groups that are selected based on the cure mechanism desired for the composition. Typically, the cure mechanism is either by means of condensation cure or addition cure, but is generally via an addition cure process. For condensation reactions, two or more R groups per molecule should be hydroxyl or hydrolysable groups such as alkoxy group having up to 3 carbon atoms. For addition reactions, two or more R groups per molecule may be unsaturated organic groups, typically alkenyl or alkynyl groups, preferably having up to 8 carbon atoms.

In one embodiment, the one or more slip additives comprises a polyhedral oligomeric silsesquioxane (POSS). POSS compounds are monodisperse nanostructured chemicals. POSS compounds have hybrid (e.g., organic-inorganic) compositions in which the internal frameworks are primarily comprised of inorganic silicon-oxygen bonds. The exterior of the nanostructure includes both reactive and/or nonreactive organic functionalities (R), which ensure compatibility and tailorability of the nanostructure with organic polymers. POSS compounds may be of low density, may exhibit excellent fire retardancy, and may range in diameter from, e.g., from about 0.5 nm to about 50 nm. In some embodiments, the POSS compounds have specific organic groups that are selected to ensure compatibility with the other components of the composition for a TPV.

POSS compounds may be represented by the formula [RSiO_{1.5}]ₓ, where x is an integer (such as from about 2 to about 36, such as from about 4 to about 24, such as from about 4 to about 15, such as from about 6 to about 12) representing a molar degree of polymerization, and each instance of R represents a substituent (e.g., each instance of R independently selected from H, siloxy, hydrocarbyl, cyclic or linear, saturated or unsaturated, aliphatic or aromatic groups, that may additionally include reactive functionalities such as alcohols, thiols, esters, amines, amides, aldehydes, ketones, olefins, ethers, thioethers, epoxides, carbamates, carbonates, acid anhydrides, carboxylic acids, acyl halides, amines, nitriles, imines, isocyanates, nitro, arenes, or halides). The hydrocarbyl group may be alkyl (such as from C₁ to C₁₀), alkenyl (such as from C₂ to C₁₀), alkynyl (such as from C₂ to C₁₀), aryl (such as phenyl and benzyl), or heteroaryl. In one embodiment, the POSS compound is octamethyl POSS, octaisobutyl POSS, octavinyl POSS, or trisilanolisobutyl POSS. In one embodiment, the POSS compound is octaisobutyl POSS having a molecular weight (M_{w} or M_{N}) in a range of 500-1,200 g/mol, 600-1,100 g/mol, 700-1,000 g/mol, 800-950 g/mol, 820-900 g/mol, 850-900 g/mol, 860-880 g/mol.

In one embodiment, a POSS compound is added as a blend or masterbatch with one or more polypropylene homopolymers and one or more random copolymers of polypropylene. The blend may comprise 1-70 wt %, 2-50 wt %, 3-40 wt %, 4-30 wt %, 5-20 wt %, 7-15 wt %, 8-12 wt %, or about 10 wt % of the POSS compound relative to a total weight of the POSS compound, the one or more polypropylene homopolymers, and the one or more random copolymers of polypropylene. The one or more polypropylene homopolymers and/or the one or more random copolymers of polypropylene, by themselves or in combination, may have a melt flow rate (230° C./2.16 kg) in a range of 0.1-70, 0.5-60, 1-50, 10-40, 15-30, 18-25, or about 20.

In one embodiment, the POSS compound may have a surface free energy in a range of 1-300 mJ/m², 5-250 mJ/m², 8-200 mJ/m², 10-150 mJ/m², 12-100 mJ/m², 13-50 mJ/m², 15-20 mJ/m², or about 17 mJ/m². In one embodiment, the POSS compound has a relative density in a range of 0.90-1.20 g/mL, 0.95-1.18 g/mL, 1.00-1.17 g/mL, 1.05-1.16 g/mL, 1.08-1.15 g/mL, 1.10-1.15 g/mL, 1.12-1.14 g/mL, or about 1.13 g/mL. In one embodiment, the POSS compound has a bulk density in a range of 0.50-1.00 g/mL, 0.52-0.95 g/mL, 0.55-0.90 g/mL, 0.60-0.85 g/mL, 0.60-0.80 g/mL, 0.61-0.75 g/mL, 0.62-0.70 g/mL, or 0.62-0.65 g/mL, or about 0.63 g/mL. In one embodiment, the POSS compound may be present in the TPV composition at 0.1-15 wt %, 0.2-12 wt %, 0.5-10 wt %, 1-9 wt %, 2-8 wt %, 3-6 wt %, or 4-5 wt % relative to a total weight of the composition.

### Process Aid

In one embodiment, the composition for a TPV comprises a process aid, for instance, process oil. A process oil may also be called a softening agent. Process oil may be present in three different forms, for instance, extension oil, which is oil present in an oil-extended rubber, free oil, which is oil added during the vulcanization process, and curative-in-oil, which is oil used to dissolve/disperse the curative. The process oils of the three forms may be the same process oil or may be more than one type. In one embodiment the process oil (as an individual process oil used above or as combined process oils) is a low aromatic/sulfur content oil. Here, the process oil has an aromatic content of less than 5 wt %, less than 4 wt %, less than 3 wt %, less than 2 wt %, less than 1.5 wt %, less than 1 wt %, less than 0.5 wt %, less than 0.1 wt %, less than 0.05 wt %, less than 0.03 wt %, less than 0.01 wt %, or 0 wt % relative to a total weight of the process oil. The process oil may have a sulfur content of less than 5 wt %, less than 4 wt %, less than 3 wt %, less than 2 wt %, less than 1.5 wt %, less than 1 wt %, less than 0.5 wt %, less than 0.1 wt %, less than 0.05 wt %, less than 0.03 wt %, less than 0.01 wt %, or 0 wt % relative to a total weight of the process oil. In one embodiment, the process oil is essentially or completely free of aromatics and/or sulfur. In one embodiment, the process oil comprises at least 80 wt % saturates, at least 85 wt % saturates, at least 90 wt % saturates, at least 95 wt % saturates, or at least 99 wt % saturates. In one embodiment, the process oil comprises less than 3 wt %, less than 1 wt %, less than 0.5 wt %, less than 0.1 wt %, or 0 wt % polar compounds. In one embodiment, the process oil is essentially or completely free of polar compounds.

In one embodiment, the composition for a TPV comprises a combined weight percentage of all process oils in a range of 5-40 wt %, 6-39 wt %, 7-38 wt %, 8-37 wt %, 9-36 wt %, 10-35 wt %, 11-34 wt %, 12-33 wt %, 13-32 wt %, 14-31 wt %, 15-30 wt %, 16-30 wt %, 17-30 wt %, 18-30 wt %, 17-30 wt %, 19-30 wt %, 20-30 wt %, 21-30 wt %, 22-30 wt %, 23-30 wt %, 24-30 wt %, 25-30 wt %, 26-30 wt %, 27-30 wt %, or 28-30 wt % relative to a total weight of the composition.

The process oil may comprise a mineral oil. As used herein, mineral oils refer to any hydrocarbon liquid of lubricating viscosity (i.e., a kinematic viscosity at 100° C. of 1 mm²/s or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat. In other embodiments, the process oil may comprise a synthetic process oil such as polylinear alpha-olefins, polybranched alpha-olefins, and hydrogenated polyalphaolefins.

A common classification system for mineral oils is to identify them as either “paraffinic”, “naphthenic”, or “aromatic” oil based on the relative content of paraffinic, naphthenic, and aromatic moieties in the oil. An aromatic oil is defined as a mineral oil having greater than or equal to 20% aromatic moieties. Typical aromatic oils comprise 35-55% paraffinic moieties, 10-35% naphthenic moieties, and 30-40% aromatic moieties. In one embodiment the process oil is a paraffinic oil. Paraffinic oils are defined as mineral oils having greater than or equal to 60% paraffinic moieties, less than 40% naphthenic moieties, and less than 20% aromatic moieties. Typical paraffinic oils comprise 60-80% paraffinic moieties, 20-40% naphthenic moieties, and 0-10% aromatic moieties. Illustrative paraffinic oils are described in U.S. Patent Application Publication No. 2008/0188600 A1, incorporated herein by reference in its entirety.

In one embodiment, the process oil has a kinematic viscosity at 100° C. in a range of 1-500 cSt, 2-450 cSt, 3-400 cSt, 4-350 cSt, 5-300 cSt, 6-250 cSt, 7-200 cSt, 8-150 cSt, 9-100 cSt, 9-50 cSt, 9-20 cSt, 9-19 cSt, 9-18 cSt, 9-17 cSt, 9-16 cSt, 9-15 cSt, 9-14 cSt, 9-13 cSt, 9-12 cSt, 8-11 cSt, or 8-10 cSt. In one embodiment, the process oil has a density in a range of 0.80-0.95 g/cm³, 0.81-0.94 g/cm³, 0.82-0.93 g/cm³, 0.83-0.92 g/cm³, 0.84-0.91 g/cm³, 0.85-0.90 g/cm³, 0.86-0.89 g/cm³, 0.86-0.88 g/cm³, or about 0.87 g/cm³.

### Additives

In one embodiment, the composition for a TPV further comprises one or more additives. The additive may be a mineral or an inorganic filler, a colorant, a pigment, a stabilizer, an antioxidant, a fiber, a reinforcer, a UV stabilizer, a release agent, a processing aid, a nucleating agent, carbon black, impact modifier, a flame retardant, a lubricant, a reinforcing filler, a non-reinforcing filler, a wax, a nucleating agent, a compatibilizer, an antiblocking agent, an anti-static agent, a foaming agent, an abrasion enhancing additive, an acid scavenger, or some other additive generally used in thermoplastic elastomers and vulcanizates. The one or more additives may be present in the composition for a TPV at an individual or combined weight ratio in a range of 0.05-8 wt %, 0.1-7 wt %, 0.5-6 wt %, 0.8-5.5 wt %, 1.0-5.0 wt %, 1.5-4.5 wt %, 2.0-4.0 wt %, or 2.5-3.5 wt %, relative to a total weight of the composition.

In one embodiment, the composition for a TPV further comprises one or more inorganic fillers. The inorganic filler may be added to reinforce the thermal resistance and the mechanical properties of a molded article, and those commonly used in the technical field to which the present invention pertains may be used without specific limitations. The inorganic filler may be talc, clay, silica, metal hydride, feldspar, calcium carbonate, wollastonite, calcium sulfate, magnesium oxide, calcium stearate, mica, calcium silicate, titanium dioxide, mica, fiberglass, and mixtures thereof. One or more inorganic fillers may be present in the composition at a combined or individual concentration in a range of 0.01-8 wt %, 0.1-7 wt %, 0.2-6 wt %, 0.5-5 wt %, 1-5 wt %, or 2-4 wt %.

In order to secure the dispersibility of the inorganic filler, an organic modified inorganic filler may be used. The shape of the inorganic filler is not specifically limited. However, considering the dispersibility of the inorganic filler and workability of the composition, inorganic filler may be in the form of particles having an average diameter in a range of 1-10 μm, 2-8 μm, 2-6 μm, 2-5 μm, or 3-4 μm. In one embodiment, the inorganic filler is talc in the form of microparticles. In one embodiment, the inorganic filler or other additive in the form of particles may have an aspect ratio in a range of 1:1-20:1, 1.5:1-15:1, 2:1-12:1, 3:1-11:1, 4:1-10:1, or 5:1-10:1.

In one embodiment, the composition for a TPV comprises carbon black at a weight percentage in a range of 0.5-4 wt %, 0.8-3.5 wt %, 1.0-3.0 wt %, 1.5-2.5 wt %, 1.8-2.2 wt %, or about 2 wt % relative to a total weight of the composition. The carbon black may include furnace black, Ketjen black, or some other form. In other embodiments, the composition may comprise other forms of carbon as a filler, for instance, active carbon, carbon nanoparticles, carbon nanorods, carbon nanotubes, carbon fibers, graphene, graphite, expandable graphite, graphene oxide, exfoliated graphite nanoplatelets, thermally reduced graphene oxide, chemically reduced graphene oxide, and mixtures thereof.

### Vulcanization Process

Dynamically vulcanized thermoplastic elastomers (as thermoplastic vulcanizates), similar to traditional thermoplastic elastomers, have a combination of both thermoplastic and elastic properties. The thermoplastic vulcanizates are prepared by mixing and shearing a thermoplastic polymer, a vulcanizable elastomer, and a curing agent. The vulcanizable elastomer is dynamically cured during the shearing and mixing and is intimately and uniformly dispersed as a particulate phase within a continuous phase of the thermoplastic polymer. This morphology may be considered a sea-islands structure, where islands of elastomer are dispersed in a sea of the thermoplastic polymer. See, for example U.S. Pat. Nos. 4,130,535; 4,311,628; 4,594,390; and 6,147,160, each incorporated herein by reference in their entirety. In one embodiment, the particulate phase of the elastomer has an average particle diameter in a range of 1-20 μm, 2-18 μm, 2-16 μm, 3-15 μm, 4-12 μm, 4-10 μm, or 5-8 μm. Typically, the thermoplastic forms a “continuous” phase in the TPV, which is desirable for later processing the TPV into articles of manufacture.

Any process for fabricating TPVs may be employed for forming the thermoplastic vulcanizates of the present disclosure and as further described herein. Generally, the rubber of the TPV has already been at least partially vulcanized. For example, the individual materials and components, such as the one or more rubber component, thermoplastic component, and any additional additives, may be mixed at a temperature above the melting temperature of the thermoplastic component to form a melt. Illustrative mixing equipment may include, but is not limited to, extruders with kneaders or mixing elements with one or more mixing tips or flights, extruders with one or more screws, and extruders of co- or counter-rotating type. Suitable mixing equipment may include, for example, BRABENDER™ mixers, BANBURY™ mixers, BUSS™ mixers and kneaders, and FARREL™ continuous mixers. One or more of those mixing equipment, including extruders, may be used in series, without departing from the scope of the present disclosure

In general, the dynamic vulcanization takes place within a reactor, as will be described in greater detail below. In one or more embodiments, the rubber and the thermoplastic resin are introduced to the reactor as solids. The rubber and plastic are then mixed at a temperature above the melt temperature of the thermoplastic resin. Following this initial blending, a crosslinking agent is introduced to the blend and curing of the rubber proceeds.

Multiple-step processes may also be employed whereby individual components of the composition or any combination of components may be added at any point before, during, or after dynamic vulcanization. In one embodiment, two or more components are combined to form a masterbatch in order to improve mixing. For instance, an ingredient such as zinc oxide, stearic acid, or a stabilizer may be blended with the thermoplastic polyolefin in advance, and added during the dynamic vulcanizing process in the form of pellets. This avoids the disadvantages of adding zinc oxide powder directly to the reactor. In another embodiment, other ingredients that may be in the form of a powder may be obtained in the form of thermoplastic polyolefin pellets as a masterbatch with one or more ingredients dispersed within. For instance, carbon black may be present at a concentration in a range of 30-50 wt % and dispersed within pellets of polypropylene. As used herein, “masterbatch” refers to any composition, including liquids, solids, and melt blends, that comprises two or more ingredients mixed together that are added at some point in the mixing or dynamic vulcanization process.

Dynamic vulcanization may include phase inversion. As those skilled in the art appreciate, dynamic vulcanization may begin by including a greater volume fraction of rubber than thermoplastic resin. As such, the thermoplastic resin may be present as the discontinuous phase when the rubber volume fraction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Masterbatch ingredients, hindered phenol antioxidants, and any other additives may be present within the composition when dynamic vulcanization is carried out, although masterbatch, hindered phenol antioxidants, and/or any one or more other additives may be added to the composition after the curing and/or phase inversion (e.g., after the dynamic vulcanization portion of processing). Masterbatch and/or other additional ingredients may be included after dynamic vulcanization by employing a variety of techniques. The masterbatch and/or other additional ingredients may be added while the thermoplastic vulcanizate remains in its molten state from the dynamic vulcanization process. For example, the additional ingredients may be added downstream of the location of dynamic vulcanization within a process that employs continuous processing equipment, such as a single or twin screw extruder. The thermoplastic vulcanizate may be “worked-up” or pelletized, subsequently melted, and the additional ingredients can be added to the molten thermoplastic vulcanizate product. This latter process may be referred to as a “second pass” addition of the ingredients. Similarly, one or more ingredients of the TPV composition may be divided into two or more batches and added at different times or locations in the mixing, melt blending, and/or dynamic vulcanization process.

Despite the fact that the rubber may be partially or fully cured, the thermoplastic vulcanizates of the present disclosure may be processed and reprocessed by conventional plastic processing techniques such as extrusion, co-extrusion, injection molding, blow molding, vacuum forming, thermos-forming, elasto-welding, 3D printing, pultrusion, compression molding, and other fabrication techniques. In one embodiment, the thermoplastic vulcanizate may be subjected to injection molding to form an automotive component, including but not limited to a corner molding compound. The injection molding may involve heating the TPV at a melt temperature in a range of 220-280° C., 230-275° C., 240-270° C., 250-265° C., or about 260° C. The injection speed may be in a range of 0.01-0.15 m/s, 0.03-0.12 m/s, or 0.05-0.10 m/s. The mold temperature may be in a range of 30-45° C., or 35-40° C.

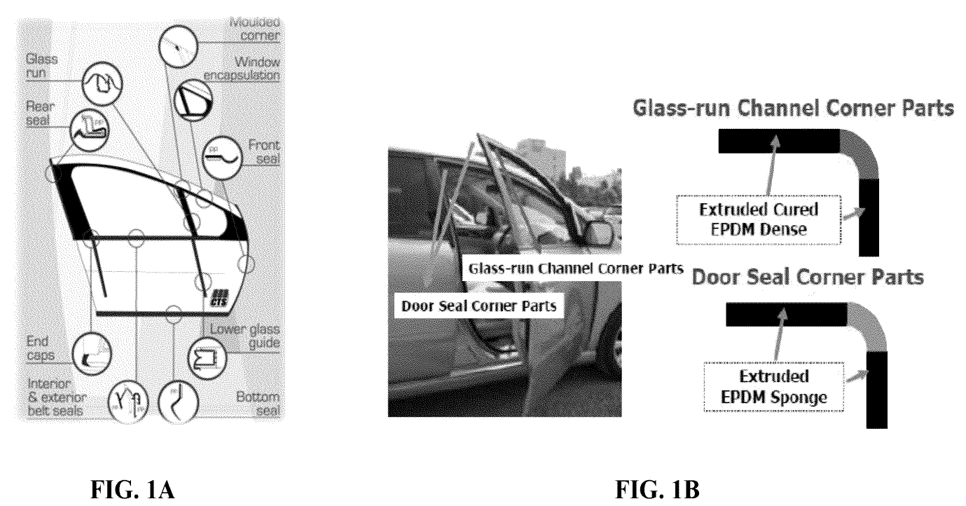

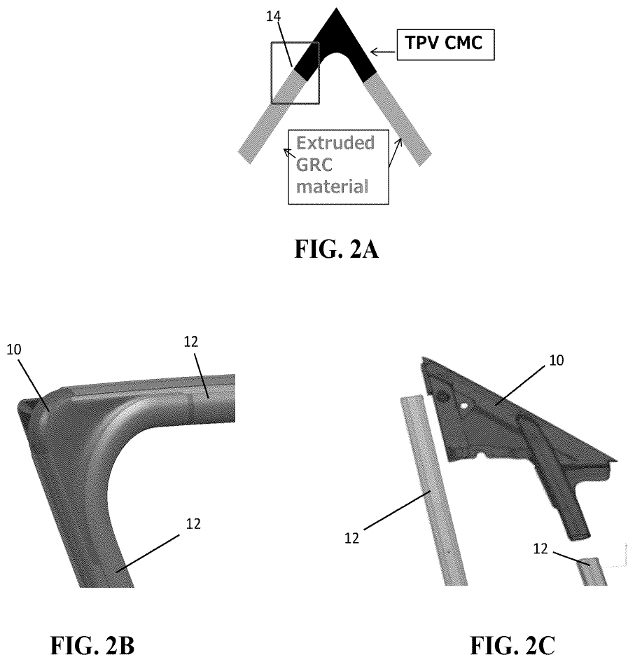

FIGS. 1A and 1B show example arrangements of a corner molding compound and a glass-run channel on a car door. FIGS. 2A-2C further illustrate example assemblies between a corner molding compound 10 and a glass-run channel 12. FIG. 2A shows an interface 14 in an assembly where the glass-run channel and the corner molding compound are adhered to each other. FIG. 2C is an exploded view of another assembly.

In one embodiment, the TPV may be used in some other application or some other part besides a corner molding compound. For example, the TPV may be used as a glass-run channel or some other weather seal or fluid seal such as primary and secondary body seals including trunk lid seals, door-to-door seals, rocker seals, and hood seals. The TPV may be used in other automotive applications such as a bumper, a door handle, and skins such as dashboard, instrument panel, and interior door skins; an airbag cover, or an airbag module housing. Uses may extend beyond those specific to automotive applications, for instance, the TPV may be used as or with an air duct, a gear, a cog, a wheel, a drive belt, a gasket, an O-ring, a door panel, a pipe seal, a hose, an extruded tape, a brake part, a case or insulator for an electronic device, as fabric for carpets, clothes, or bedding, as a filler for pillows or mattresses; or within an expansion joint for construction.

Additionally, the TPV may be useful for producing “soft touch” grips in products such as pens, razors, toothbrushes, handles; toys; small appliances; keyboard covers;

packaging; kitchenware; recreation, sport, and leisure products; consumer electronics; PVC and silicone rubber replacement medical tubing; industrial hoses; and shower tubing. Other articles made with the TPV include marine belting, pillow tanks, ducting, dunnage bags, architectural trim and molding, collapsible storage containers, synthetic wine corks, IV and fluid administration bags, examination gloves, geo textiles, appliance door gaskets, liners, gaskets, mats, syringe plunger tips, conveyor belts, modifiers for rubber concentrates to reduce viscosity, single-ply roofing compositions, cookware, book covers, storage ware, medical devices, sterilizable medical devices, sterilization containers, sheets, crates, containers, wire and cable jacketing, pipes, geomembranes, chair mats, tubing, profiles, instrumentation sample holders and sample windows, outdoor furniture, e.g., garden furniture, playground equipment, boat and water craft components, and other such articles.

In other embodiments the TPV may be used for flexible pipes, tubing, hoses, and flexible structures, such as flexible pipes, flow lines and flexible umbilicals used in transporting fluids in petroleum production. These flexible structures may transport hydrocarbons extracted from an offshore deposit and/or can transport water, heated fluids, and/or chemicals injected into the formation in order to increase the production of hydrocarbons. Certain embodiments of the present TPV may be used to form the outer covering of a thermoplastic composite pipe (a flexible or rigid pipe), and may be used as thermal insulation.

### Material Properties of TPV-CMC

In one embodiment, the thermoplastic vulcanizate (TPV) of the present invention has a tensile strength at break in a range of 5-15 MPa, 6-14 MPa, 7-13 MPa, 8-12 MPa, 8.5-11.5 MPa, 9.0-11.5 MPa, 9.5-11.0 MPa, or 10.0-10.5 MPa. In one embodiment, the TPV has a tensile strength at break in a range of 4.0-12.0 MPa, 4.5-11.5 MPa, 5.0-11.0 MPa, 5.5-10.5 MPa, 6.0-10.0 MPa, 6.5-9.5 MPa, 7.0-9.0 MPa, or 7.5-8.5 MPa. In one embodiment, the TPV has an elongation at break in a range of 300-900%, 350-850%, 400-800%, 450-750%, 500-740%, 550-730%, 580-720%, 590-715%, 600-710%, 610-700%, 630-690%, 640-685%, 645-685%, 650-685%, 655-685%, 660-685%, 665-685%, 670-685%, 675-685%, 680-720%, 685-715%, 690-710%, 695-705%, or 697-700%. In one embodiment, the TPV has a modulus at 100% in a range of 2.5-5.5 MPa, 2.8-5.2 MPa, 3.0-5.0 MPa, 3.1-4.9 MPa, 3.2-4.8 MPa, 3.3-4.7 MPa, 3.4-4.6 MPa, 3.5-4.5 MPa, 3.6-4.4 MPa, 3.7-4.3 MPa, 3.8-4.2 MPa, 3.8-4.1 MPa, or 3.9-4.0 MPa. The tensile strength at break, elongation at break, and/or modulus may be measured by a method described by the ISO 37 standard.

In one embodiment, the TPV has a compression set following 22 h at 70° C. in a range of 30-65%, 38-62%, 40-60%, 41-59%, 42-58%, 43-57%, 44-56%, 45-55%, 46-54%, 47-53%, 48-52%, 49-51%, 49-50%, 50-66%, 52-64%, 54-62%, or 56-60%. In one embodiment, the TPV has a compression set following 70 h at 125° C. in a range of 50-90%, 55-85%, 60-80%, 61-79%, 62-78%, 63-77%, 64-76%, 65-75%, 66-74%, 67-73%, 68-72%, 69-71%, or 69-50%. In one embodiment, the TPV has a compression set following 168 h at 100° C. in a range of 50-75%, 52-72%, 55-70%, 57-68%, 60-65%, 60-85%, 65-82%, 70-80%, 72-78%, or 73-77%. The compression set may be measured by a method described by the ISO 815 standard. The compression set may also be considered the elastic recovery.

In one embodiment, the TPV of the present invention has a heat of fusion in a range of 10-50 J/g, 12-48 J/g, 14-45 J/g, 15-40 J/g, 16-35 J/g, 17-32 J/g, 18-31 J/g, 19-30 J/g, 20-29 J/g, 21-28 J/g, or 22-26 J/g. The heat of fusion may be measured by differential scanning calorimetry (DSC).

In one embodiment, the TPV has a density in a range of 0.82-1.05 g/cm³, 0.83-1.03 g/cm³, 0.84-1.00 g/cm³, 0.85-0.99 g/cm³, 0.86-0.98 g/cm³, 0.87-0.97 g/cm³, 0.88-0.96 g/cm³, 0.88-0.95 g/cm³, 0.88-0.94 g/cm³, 0.88-0.93 g/cm³, 0.88-0.92 g/cm³, 0.88-0.91 g/cm³, or 0.89-0.90 g/cm³. In one embodiment, the TPV has a density in a range of 0.89-1.10 g/cm³, 0.90-1.08 g/cm³, 0.91-1.06 g/cm³, 0.92-1.04 g/cm³, 0.90-1.02 g/cm³, 0.90-1.00 g/cm³, 0.90-0.98 g/cm³, 0.90-0.96 g/cm³, 0.90-0.94 g/cm³, 0.90-0.93 g/cm³, 0.90-0.92 g/cm³, or about 0.91 g/cm³. The density may be measured by a method described by the ISO 1183 standard or by some other method.

In one embodiment, the TPV has a Shore A hardness as measured with a 15 s delay in a range of 70.0-90.0, 70.5-89.5, 71.0-89.0, 71.5-88.5, 72.0-88.0, 72.5-87.5, 73.0-87.0, 73.5-86.5, 74.0-86.0, 74.5-85.5, 75.0-85.0, 75.5-84.5, 76.0-84.0, 76.5-83.5, 77.0-83.0, 77.5-82.5, 78.0-82.0, 78.5-81.5, 79.0-81.0, 79.5-80.5, or 79.0-80.0. The Shore A hardness may be measured by a method described in the ISO 868 standard.

In one embodiment, the TPV has a crystallinity in a range of 0-20%, 8-20%, 9-19%, 10-18%, 11-17%, 12-16%, 13-15%, 14-15%, or 14-17%. In one embodiment the TPV has a crystallinity of less than 20%, less than 18%, less than 17%, less than 16%, less than 15%, less than 14%, less than 13%, less than 12.5%, less than 12%, less than 11%, or less than 10%. The crystallinity may be measured by DSC.

In one embodiment, the TPV has a melt flow rate (MIR) measured at 230° C. and 21 N in a range of 1-55 g/10 min, 2-45 g/10 min, 3-42 g/10 min, 4-40 g/10 min, 5-35 g/10 min, 6-34 g/10 min, 10-33 g/10 min, 12-32 g/10 min, 13-31 g/10 min, 14-30 g/10 min, 15-30 g/10 min, 50-80 g/10 min, 55-75 g/10 min, 58-72 g/10 min, 60-70 g/10 min, 61-69 g/10 min, 62-68 g/10 min, 63-66 g/10 min. In one embodiment, the TPV has a viscosity measured at 200° C. and at a 200 s⁻¹ or 204 s⁻¹ shear rate in a range of 90-250 Pa·s, 95-250 Pa·s, 97-250 Pa·s, 100-250 Pa·s, 110-225 Pa·s, 120-220 Pa·s, 130-210 Pa·s, 140-200 Pa·s, 150-190 Pa·s, 160-180 Pa·s, 170-180 Pa·s, 90-120 Pa·s, 91-118 Pa·s, 92-116 Pa·s, 93-114 Pa·s, 94-112 Pa·s, 95-110 Pa·s, 96-108 Pa·s, 97-106 Pa·s, 98-104 Pa·s, or 99-102 Pa·s. In one embodiment, the TPV has a viscosity measured at 260° C. and at a 200 s⁻¹ shear rate in a range of 50-300 Pa·s, 70-280 Pa·s, 75-250 Pa·s, 80-200 Pa·s, 85-250 Pa·s, 85-200 Pa·s, 85-150 Pa·s, or 85-140 Pa·s. The viscosity may be measured by a method described in the ISO 1133 standard.

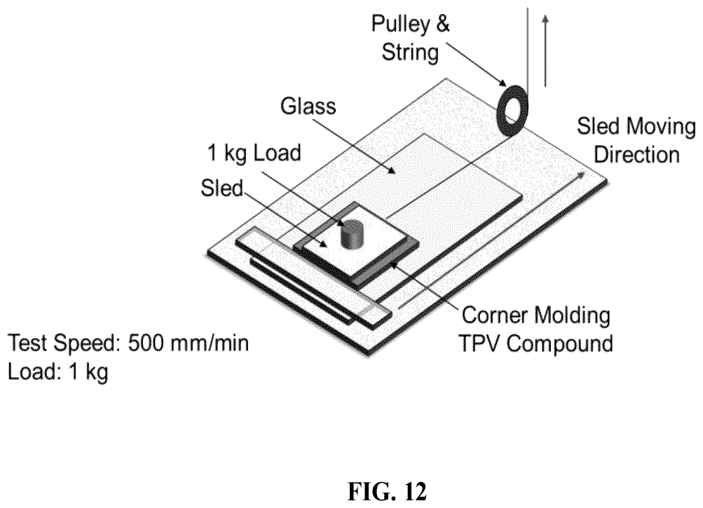

In one embodiment, the TPV has a static coefficient of friction (μₛ) in a range of 0.10-0.50, 0.12-0.45, 0.13-0.42, 0.14-0.40, 0.14-0.39, 0.15-0.38, 0.15-0.37, 0.16-0.35, 0.17-0.32, 0.18-0.31, 0.19-0.30 0.20-0.29, 0.20-0.35, 0.21-0.29, 0.22-0.28, 0.23-0.28, 0.24-0.27, or 0.25-0.26. In one embodiment, the TPV has a kinetic coefficient of friction (μ_{D}) in a range of 0.10-0.50, 0.11-0.48, 0.12-0.45, 0.13-0.42, 0.14-0.40, 0.15-0.37, 0.15-0.30, 0.16-0.35, 0.16-0.33, 0.17-0.32, 0.17-0.31, 0.18-0.30, 0.19-0.30, 0.20-0.29, 0.20-0.35, 0.21-0.29, 0.22-0.28, 0.23-0.27, 0.24-0.26, or 0.23-0.25. The static and/or kinetic coefficients of friction may be measured against a glass surface as shown in FIG. 12 or by another method.

In one embodiment, the TPV has a tear strength in a range of 25.0-40.0 kN/m, 26.0-39.0 kN/m, 27.0-38.0 kN/m, 28.0-37.5 kN/m, 29.0-37.0 kN/m, 30.0-36.5 kN/m, 30.5-36.0 kN/m, 31.0-35.5 kN/m, 31.5-35.0 kN/m, 32.0-34.5 kN/m, or 32.5-34.0 kN/m. The tear strength may be measured by a method described in the ISO 34 standard. In one embodiment, the TPV has a low temperature brittleness of less than −50° C., less than −52° C., less than −55° C., less than −57° C., less than −60° C. The low temperature brittleness may be determined by a standard such as ASTM D746, ISO 974, or ISO 812. In one embodiment, the TPV has a spiral flow length in a range of 55-75 cm, 57-72 cm, 60-70 cm, 60-68 cm, 60-67 cm, 61-66 cm, 61-65 cm, or 62-64 cm. The spiral flow length may be measured by a method described in the ASTM D 3123 standard.

In one embodiment, mechanical properties of the TPV may increase or decrease following aging. For instance, the TPV may be aged by maintaining it at a temperature in a range of 100-150° C., 110-145° C., 120-150° C., 130-140° C., 115-140° C., 120-130° C., or about 125° C. for a time in a range of 500-1,500 h, 750-1,250 h, 900-1,100 h, or about 1,000 h. With aging, the Shore A hardness may increase by 0.5-5.0%, 1.0-4.9%, 1.1-4.8%, 1.2-4.7%, 1.5-4.5%, 1.7-4.4%, 1.9-4.3%, 2.0-4.2%, 2.2-4.1%, 2.4-4.0%, 2.6-3.9%, 2.8-3.8%, 3.0-3.6%, 3.4-3.6%, 4.0-12.0%, 4.5-11.5%, 5.0-11.0%, 5.5-10.5%, 6.0-10.0%, 6.5-10.0%, 7.0-9.5%, 7.5-9.0%, or 7.8-8.5% relative to the Shore A hardness before aging. With aging, the modulus may increase by 0.5-15.0%, 1.0-14.5%, 4.0-14.2%, 5.0-14.0%, 6.0-12.0%, 6.5-11.0%, 6.8-10.5% 7.0-10.0%, or 8.0-10.0% relative to the modulus before aging.

With aging, the tensile strength may decrease by 2.0-17.0%, 2.5-16.5%, 3.0-16.0%, 3.5-15.5%, 4.0-15.0%, 4.5-14.5%, 5.0-14.0%, 5.5-13.5%, 6.0-13.0%, 6.5-12.5%, 7.0-12.0%, 7.5-11% or 8.0-10.5% relative to the tensile strength before the aging. In one embodiment, the tensile strength is decreased by 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, or 2% or less relative to the tensile strength before aging.

With aging, the elongation at break may decrease by 5-30%, 6-28%, 7-25%, 8-20%, or 9-15% relative to the elongation at break before the aging. In one embodiment, the elongation at break is decreased by 30% or less, 29% or less, 28% or less, 27% or less, 26% or less, 25% or less, 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, or 2% or less relative to the elongation at break before aging.

### Adhesion Properties of TPV-CMC with Various GRC Profiles

In one embodiment, the TPV as a corner molding compound (CMC) shows strong bondability and adhesion to glass-run channel (GRC) profiles that comprise other thermoplastic elastomers (such as TEFABLOC™ TO623, TEFABLOC™ T0113823, or TEFABLOC™ TOSE 848), thermoplastic vulcanizate (such as Santoprene™ 101-64, Santoprene™ 58 W175, Santoprene™ HR, Santoprene™ R2, TREXPRENE™ A55, TREXPRENE™ 64, or TREXPRENE™ A67BW-LF) and vulcanized rubber (such as vulcanized EPDM). As described in the results the follow, the CMC may be adhered to the GRC in a butt joint configuration. In one embodiment, the CMC is adhered to the GRC in an injection over molding process at a melt temperature of 200-300° C., 210-290° C., 220-280° C., 230-275° C., 240-270° C., 250-265° C., or about 260° C.; injection speed of 0.001-0.6 m/s, 0.003-0.5 m/s, 0.01-0.5 m/s, 0.02-0.2 m/s, or 0.05-0.1 m/s, and mold temperature of 50-80 ° C., 52-78° C., 55-75° C., 57-72° C., 60-70° C., 62-67° C., or about 65° C.

In one embodiment, the inventive TPV-CMC adhered to a vulcanized EPDM GRC have a combined adhesion strength in a range of 2.5-4.0 MPa, 2.6-3.9 MPa, 2.7-3.8 MPa, 2.8-3.7 MPa, 2.9-3.6 MPa, 3.0-3.6 MPa, 3.1-3.5 MPa, or 3.2-3.4 MPa. In one embodiment, the TPV-CMC adhered to a TPV-GRC have a combined adhesion strength in a range of 3.0-5.5 MPa, 3.1-4.0 MPa, 3.2-3.9 MPa, 3.2-1.4 MPa, 3.2-4.5 MPa, 3.3-3.8 MPa, 3.4-3.7 MPa, 3.5-3.6 MPa, 4.0-5.5 MPa, 4.1-5.2 MPa, 4.2-5.0 MPa, 4.3-4.9 MPa, 4.4-4.8 MPa, or 4.5-4.6 MPa. In one embodiment, the TPV-CMC adhered to a TPE-GRC has a combined adhesion strength in a range of 3.2-5.0 MPa, 3.3-4.0 MPa, 3.4-3.9 MPa, 3.5-3.8 MPa, 3.6-3.7 MPa, 3.4-4.9 MPa, 3.5-4.8 MPa, 3.6-4.7 MPa, 3.7-4.6 MPa, 3.8-4.5 MPa, 3.9-4.4 MPa, 4.0-4.3 MPa, 4.0-4.2 MPa, or 4.0-4.1 MPa.

In one embodiment, the inventive TPV-CMC adhered to a vulcanized EPDM GRC have a combined elongation at break in a range of 70-150%, 80-140%, 85-130%, 90-125%, 95-120%, 95-115%, 150-200%, 155-195%, 160-190%, 165-185%, 170-180%, or 175-180%. In one embodiment, the TPV-CMC adhered to a TPV-GRC have a combined elongation at break in a range of 90-300%, 91-280%, 92-275%, 93-270%, 94-265%, 95-260%, 95-240%, 95-230%, 95-220%, 96-210%, 97-200%, 98-190%, 99-180%, 100-170%, 101-160%, 102-150%, 103-140%, 95-160%, 100-155%, 105-150%, 110-145%, 115-140%, 120-135%, 120-275%, 120-180%, 125-130%, 150-290%, 155-280%, 160-275%, 165-270%, 170-265%, 175-260%, 180-250%, 185-240%, 190-235%, 195-230%, or 200-230%. In one embodiment, the TPV-CMC adhered to a TPE-GRC has a combined elongation at break in a range of 90-320%, 95-240%, 100-230%, 110-220%, 120-210%, 120-200%, 130-200%, 140-190%, 150-180%, 160-170%, 200-310, 210-300, 220-290, 230-280, 240-270, or 250-260%.

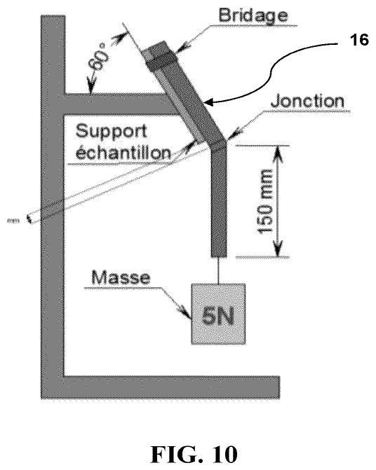

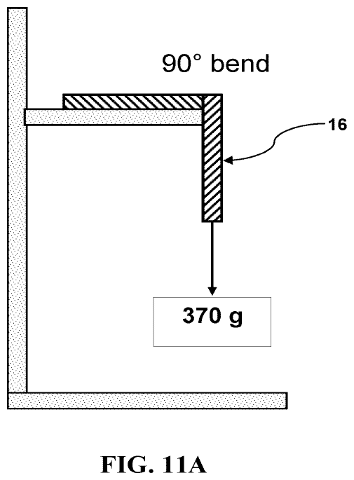

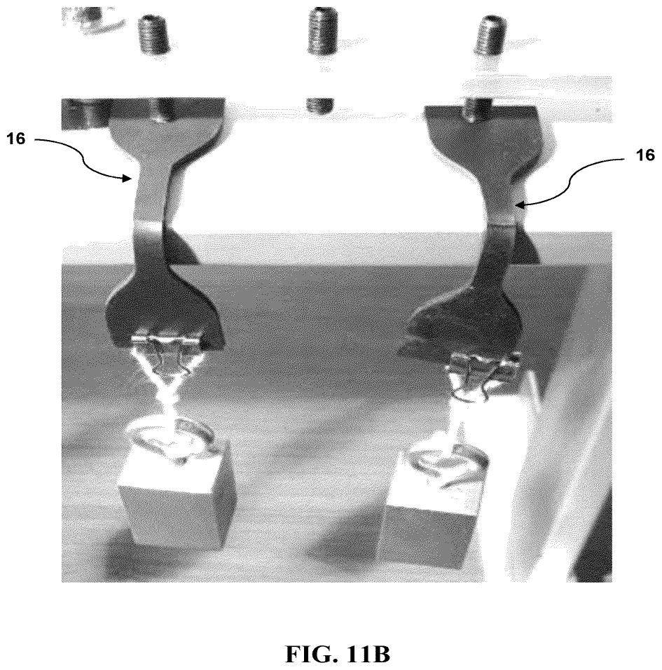

In one embodiment, the TPV-CMC 10 adhered to a vulcanized EPDM GRC, a TPE-GRC, or a TPV-GRC 12 maintains adhesion against a load of 300-500 g, 350-450 g, 360-400 g, or 370 g and at a temperature of 80-120° C., 85-110° C., 90-105° C., or 100° C., or 90° C. for a time in a period of 24-500 h, 24-450 h, 24-400 h, 36-350 h, 48-300 h, 96-200 h, 120-180 h, or 140-170 h, or 168 h, or for at least 24 h, at least 48 h, at least 96 h, at least 120 h, at least 150 h, at least 200 h, at least 300 h, at least 336 h (14 days) at least 500 h, at least 504 h (21 days), at least 552 h (23 days), at least 672 h (28 days), at least 720 h (30 days), at least 840 h (at least 35 days) or at least 1,000 h. In one embodiment, the adhesion may be maintained for over two weeks (336 h). This adhesion may be measured by an experimental setup similar to that shown in FIG. 10 or FIGS. 11A and 11B. For instance, an adhesion junction may be formed between an elongated piece of TPV-CMC with an elongated piece of vulcanized EPDM GRC, a TPE-GRC, or a TPV-GRC. The pieces may have no angle between them, or similar to FIG. 10, may form an angle in a range of 120-150°, or similar to FIGS. 11A and 11B, may form an angle of 80-100°, preferably 90°. The lower piece may be pulled against the upper piece and the upper piece may be supported up to the junction or may be supported only partway towards the junction. The cross-section area of the adhesion may be 20-100 mm², 30-80 mm², 36-70 mm², 50-60 mm², or no greater than 40 mm2, no greater than 50 mm², or no greater than 60 mm². For the given weight and cross-section area, the force per cross-section area experienced at the junction may be in a range of 50-800 kN/m², 50-500 kN/m², 60-500 kN/m², 80-450 kN/m², 100-400 kN/m², 200-350 kN/m², 250-350 kN/m², or 300-350 kN/m², or at least 50 kN/m², at least 55 kN/m², at least 60 kN/m².

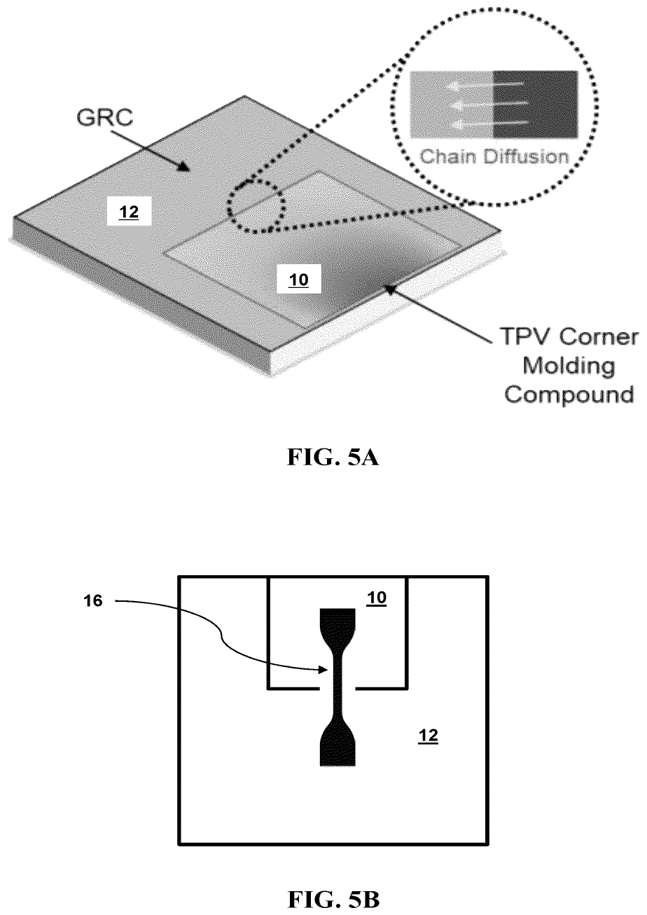

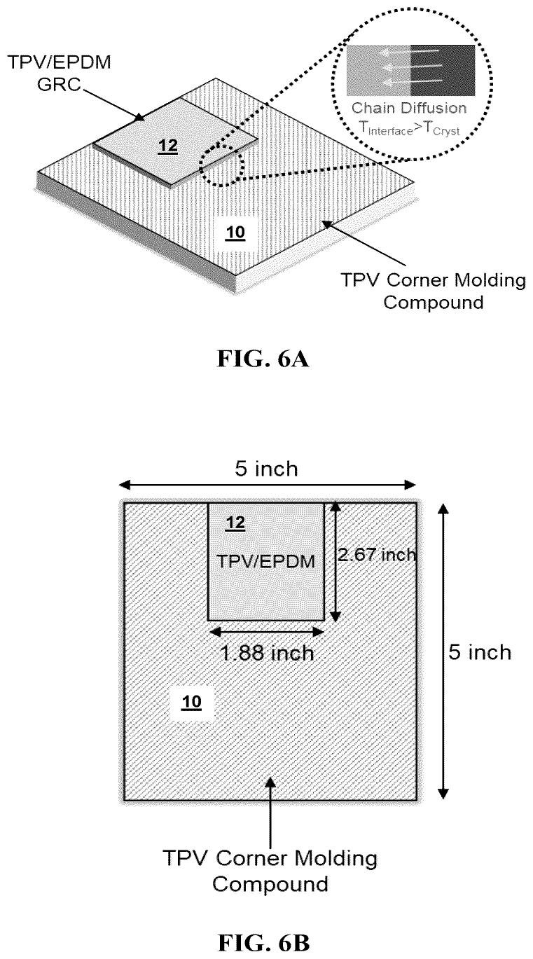

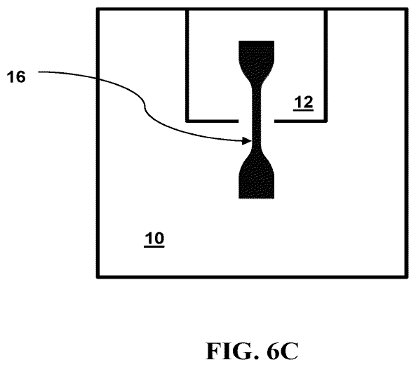

In one embodiment, the adhesion may be tested using a protocol similar to ISO 527 or ISO 37, preferably ISO 37 using type 1 test length of dumbbells, where the site of the adhesion is located in the thinnest part of the dumbbell 16, as shown in FIGS. 5B and 6C.

The examples below are intended to further illustrate protocols for preparing and characterizing the thermoplastic vulcanizate of the present disclosure, and uses thereof, and are not intended to limit the scope of the claims.

### EXAMPLES

### Materials

Keltan® 5469C from ARLANXEO or Keltan® 5469 from LANXESS was used as EPDM rubber.

RTP 2700 S-30A Saturated Styrenic Block Copolymer from RTP Company was used as styrenic TPE.

D115A from Braskem, H-521 from Braskem, FOO6EC2 from Braskem, 3927WZ from Total, and Profax 6301 from LyondellBasell, were used as polypropylene homopolymers.

Lumicene® MR60MC2 from Total was used as a polypropylene random copolymer.

HRJ-14247A from SI Group was used as phenolic resin curative.

The source of the TMPTMA co-agent was Flow Polymers FPC which is a 50/50 blend of TMPTMA co-agent and PP.

ParaLux® 6001 process oil from Chevron or ConoPure® 12P process oil from Phillips 66 Lubricants was used as the process aid.

XIAMETER™ PMX-200 Silicone Fluid, 60,000 cSt from Dow was used as a UHMW siloxane slip additive.

GENIOPLAST® PP50S12 from Wacker was used as a UHMW siloxane slip additive.

MV 603 talc or CIMTUFF® 9130 talc, both from Cimbar Performance Minerals, were used as a talc filler.

Irgastab® FS 301 FF from BASF was used as a process aid and stabilizer.

CYASORB CYNERGY SOLUTIONS® V-703 UVS from Solvay was used as an antioxidant and UV stabilizer.

Chimasorb® 119 FL from BASF was used as a UV stabilizer.

ADK Stabilizer AO-412FS from Adeka was used as an antioxidant.

Irganox® 1010 from BASF was used as an antioxidant.

Black MB from Akrochem was used as carbon black.

A commercially available TPV was used to compare the mechanical properties with the inventive TPV. A single type of this commercial TPV was used throughout the entirety of this disclosure.

Santoprene™ 101-64 from ExxonMobil was used as a TPV GRC.

TREXPRENE® A67BW-LF from Mitsubishi Chemical America was used as a TPV GRC.

EPDM 85265 and EPDM 70A are both sulphur cured elastomer formulations used for weather seals applications.

EPDM 70A was produced at Akron Rubber Development Laboratory using a standard sulphur cured formulation.

### Methods

The inventive TPV-CMC was formed by dynamic vulcanization as described above, using formulations shown in Tables 2 and 3, and then subjected to an injection molding process having the parameters shown in Table 1.

TABLE 1
Injection Molding Parameters

| Parameters | Melt Temp 500° F. |
|---|---|
| Zone 1 (° F.) | 379 |
| Zone 2 (° F.) | 379 |
| Zone 3 (° F.) | 500 |
| Zone 4 (° F.) | 500 |
| Nozzle (° F.) | 450 |
| Mold Temperature (° F.) | 150 |
| Injection Speed (in/s) | 4 |
| Shot Size (in) | 1.7 |
| Hold Pressure (Psi) | 50-70% of Injection Pressure |

### Results and Discussion

Throughout the study, the formulation-process-property inter-relationship is well established and documented to demonstrate the impact on each performance attribute.

The exemplary formulations of TPV-CMC under phenolic cured (Table 2) and peroxide cured (Table 3) categories used in the present invention are enclosed below. The mechanical properties of various TPV-CMC (phenolic and peroxide cured TPV formulations) and commercial TPV corner molding grade are listed in Table 4 below.

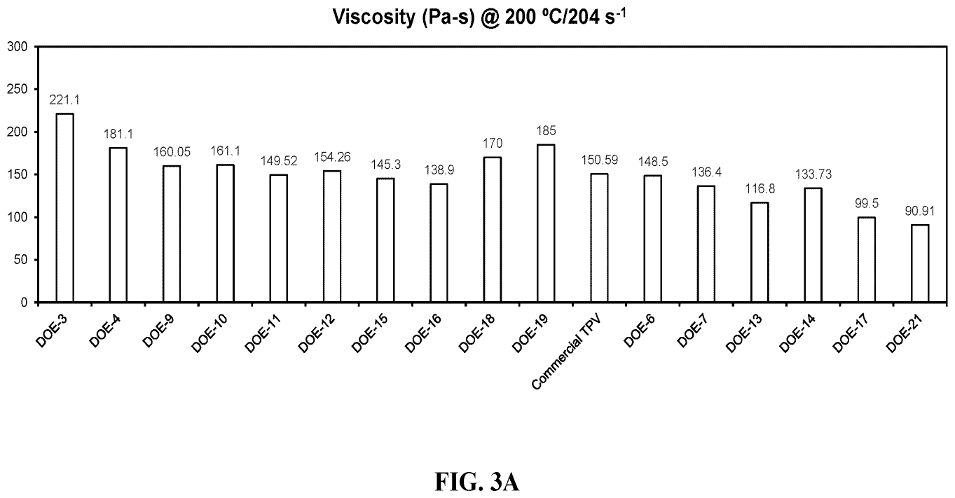

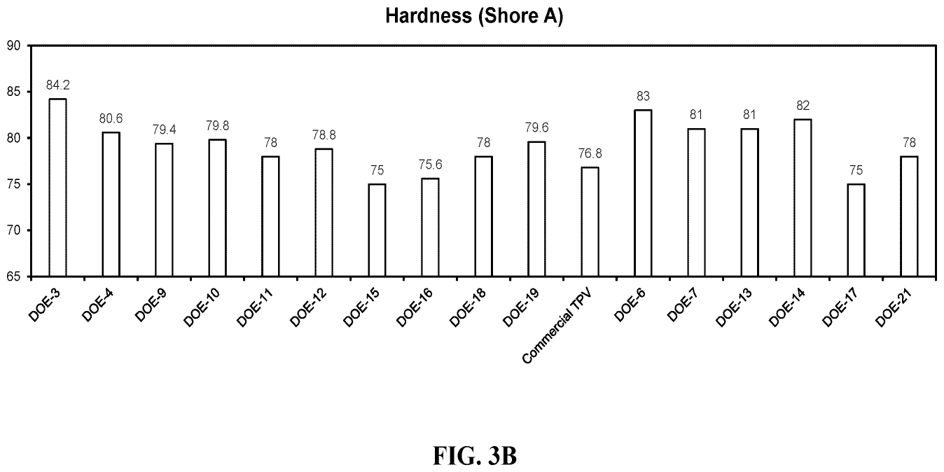

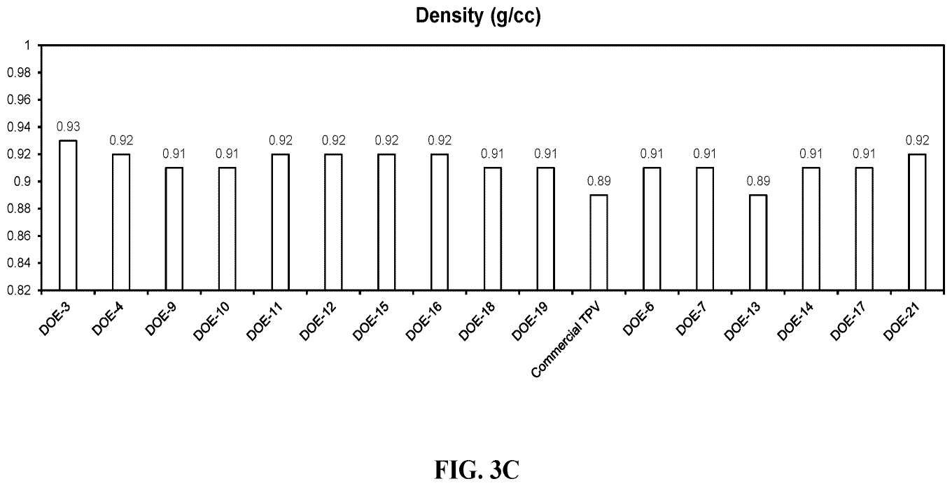

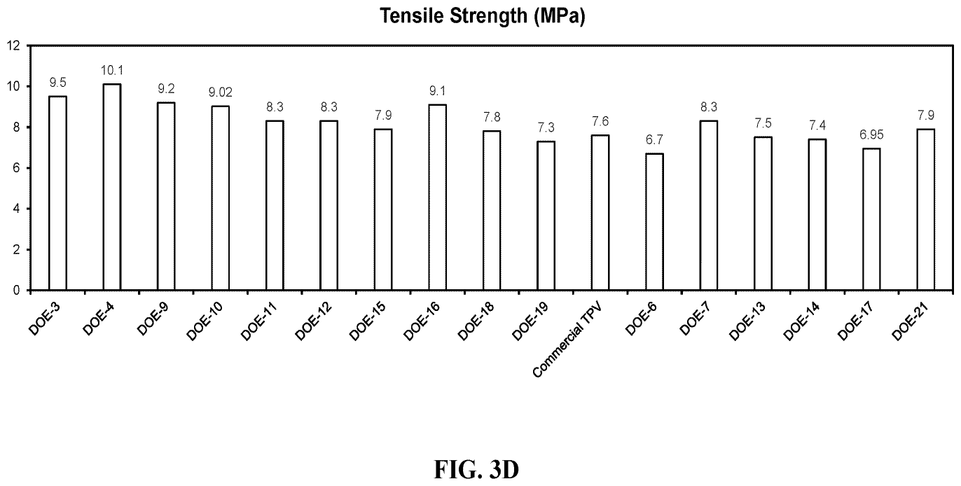

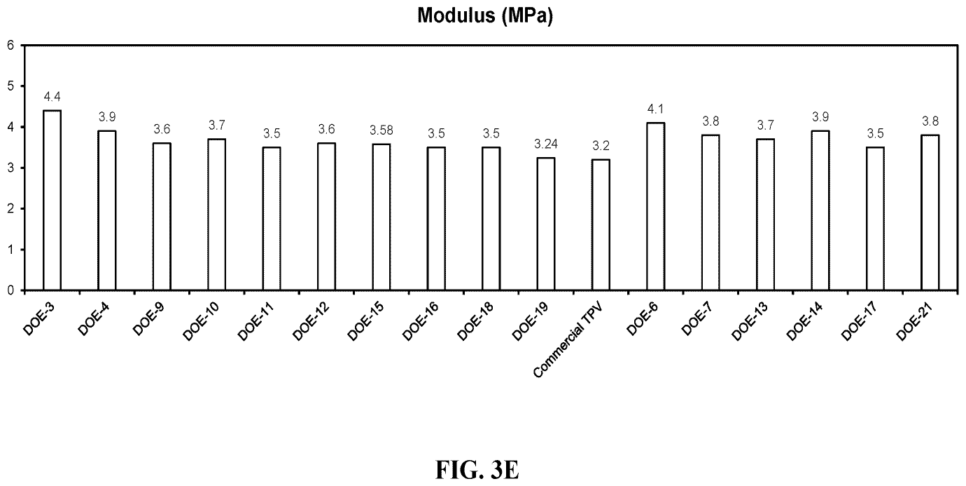

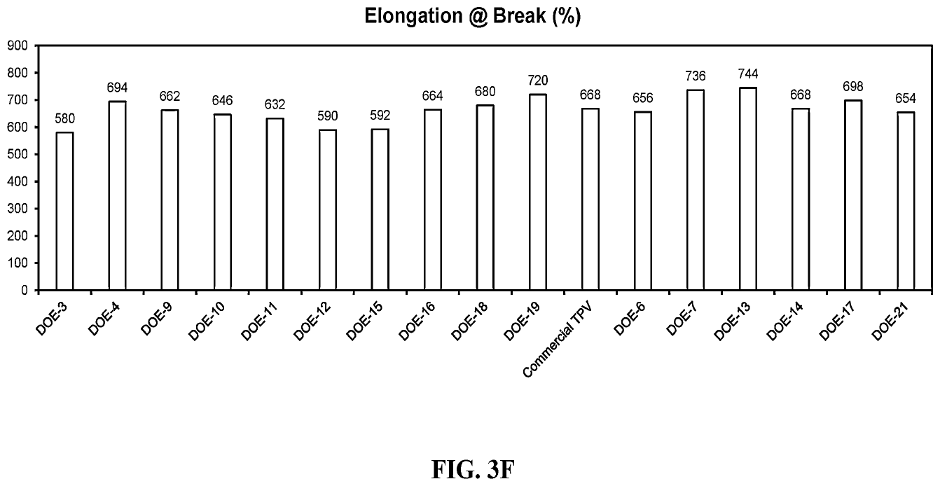

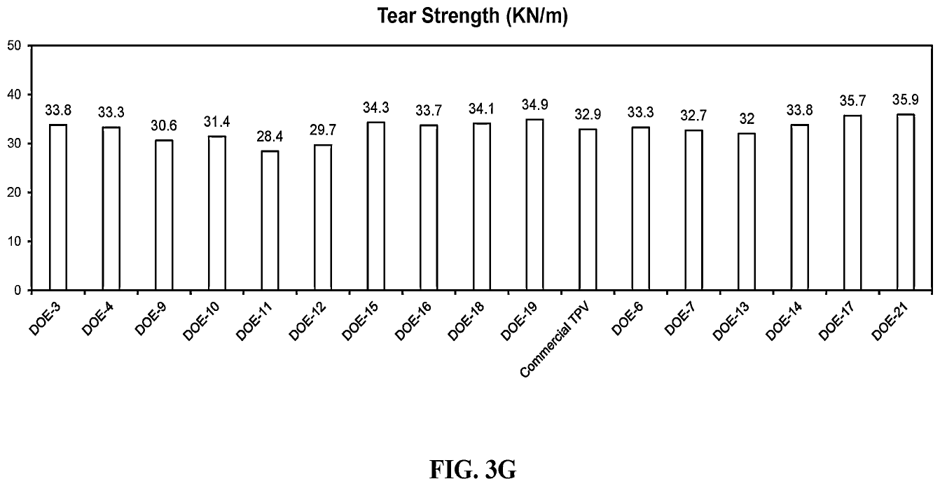

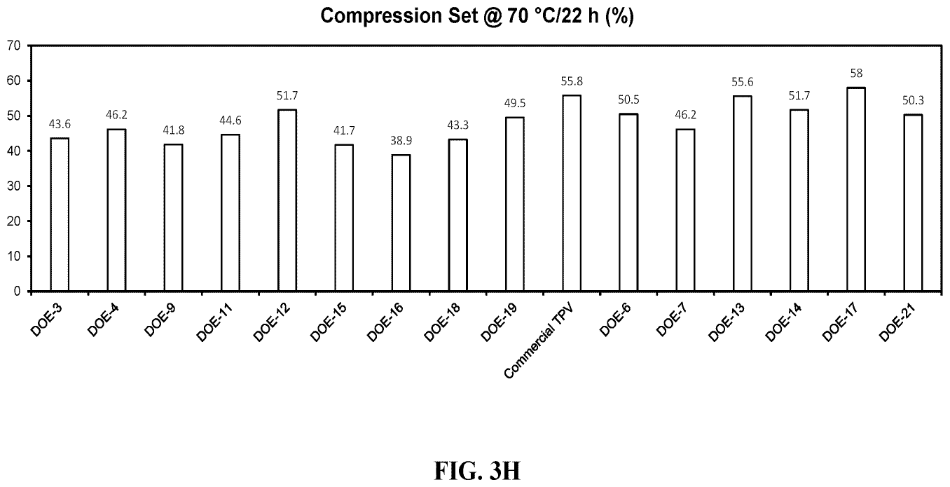

As shown in Table 4 and FIG. 3A, viscosity values for peroxide cured TPV-CMC formulations are considerably lower than the phenolic cured TPV-CMC formulations. Addition of SEBS (DOE #4&7) shows a decrease in viscosity compared to its counterpart (DOE #3&6). Similarly, addition of high flow PP homopolymer (60 MFR) reduced the viscosity, suggesting improvement in flow property (DOE #9). The silicone loading level at 5 wt % shows a slight reduction in viscosity as compared to 2 wt % in both phenolic and peroxide cured TPV-CMC formulations (Phenolic TPV-CMC: DOE #9&11; Peroxide TPV-CMC: DOE #7&13). Adding a high flow PP random-co-polymer (RACO-PP) (60 MFR) does not significantly change the viscosity of phenolic cured TPV-CMC formulations but does drastic reduce the viscosity in the peroxide cured TPV-CMC formulation (DOE #17).

The hardness and specific gravity of TPV-CMC formulations are comparable to the commercial TPV corner molding grade (Table 4 and FIGS. 3B-C). However, addition of SEBS (DOE #4&7) and high flow RACO-PP (60 MFR) (DOE #15&17) is believed to reduce hardness. On the contrary, addition of SEBS leads to an improvement in tensile strength and elongation, which clearly demonstrates the benefit of adding SEBS in both phenolic (DOE #4) and peroxide cured TPV-CMC formulations (DOE #7). These results are shown in Table 4 and FIGS. 3D and 3F. In general, phenolic cured TPV-CMC formulations displayed a superior tensile strength compared to peroxide TPV-CMC formulations and commercial TPV corner molding grade. But, the reported elongation values are much greater in peroxide cured TPV-CMC formulations compared to phenolic cured TPV-CMC formulations and commercial TPV corner molding grade. Both tensile strength and elongation decrease in phenolic cured (DOE #11) and peroxide cured TPV-CMC formulations (DOE #13) at a silicone loading level of 5 wt % as compared to its counterpart at 2 wt % (DOE #9 & 7, respectively). This is perhaps due to insufficient dispersion of ultra-high molecular weight silicone polymer in the PP matrix. FIGS. 3E, 3G, and 3H respectively show the modulus, tear strength, and compression set of the TPV-CMC formulations and the commercial TPV.

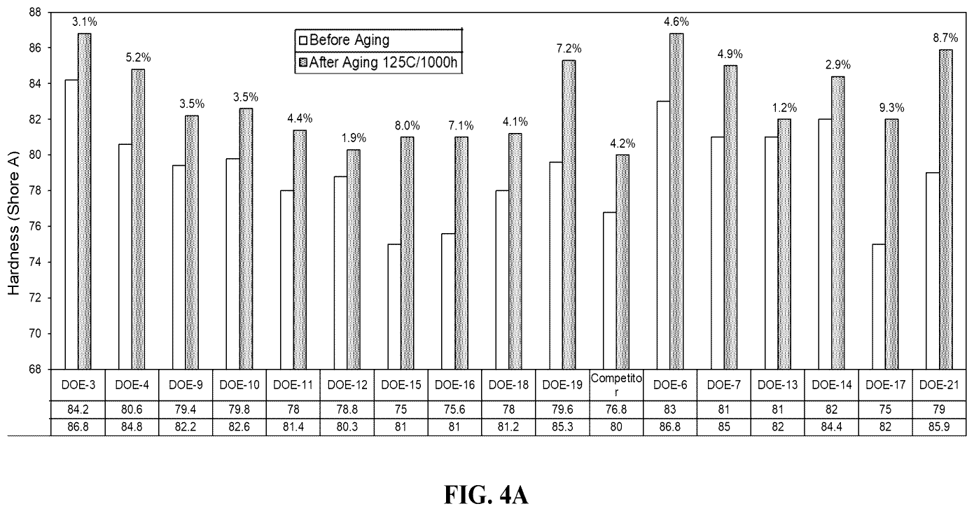

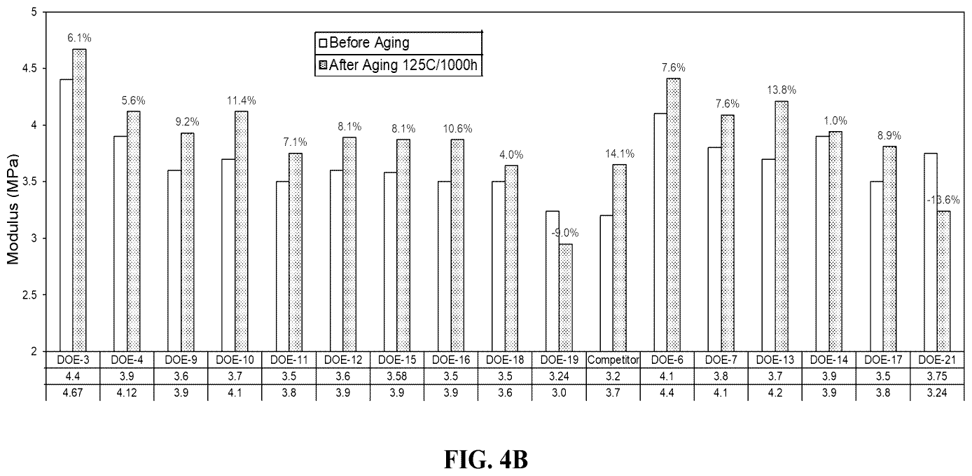

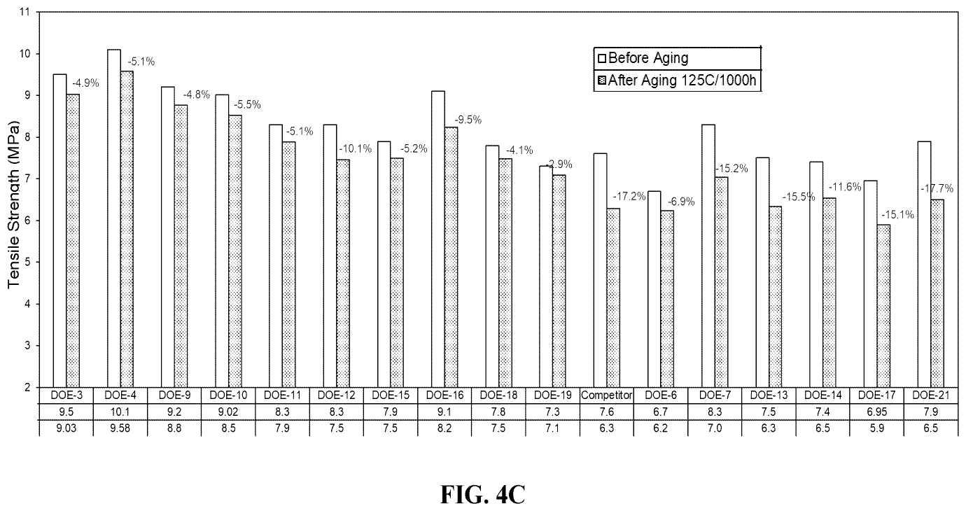

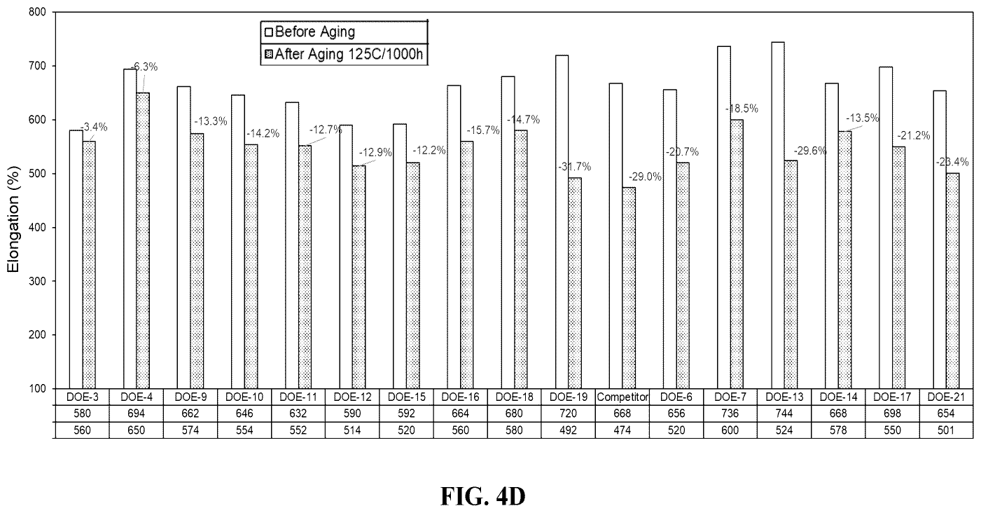

One of the performance requirements of TPV-CMC is the ability to retain mechanical properties at the elevated temperatures often encountered during service. The TPV-CMC display excellent retention of mechanical properties after aging for 1000 h at 125° C., as indicated in FIGS. 4A-4D. The retention of tensile strength, modulus and elongation at break was superior compared to the commercial TPV. In general, phenolic TPV-CMC formulations displayed superior retention of mechanical properties compared to peroxide TPV-CMC formulations.

TABLE 2
Phenolic Trexprene A80 SBW-EB TPV-CMC Formulations

| | DOE-3 | DOE-4 | DOE-9 | DOE-10 | DOE-11 | DOE-12 |
|---|---|---|---|---|---|---|
| EPDM 5469 | 41.6 | 31.7 | 31.7 | 31.7 | 32.2 | 31.9 |
| RTP 2700 S30A | 0.0 | 20.0 | 20.0 | 20.0 | 17.0 | 17.0 |
| (SEBS compound) | | | | | | |
| Braskem F006EC2 | 5.3 | 4.0 | 4.0 | 4.0 | 4.1 | 4.1 |
| Homo-PP | | | | | | |
| Braskem D115A | 16.5 | 14.5 | 0.0 | | 0.0 | 0.0 |
| Homo-PP | | | | | | |
| TOTAL 3927WZ | 0.0 | 0.0 | 14.5 | 12.5 | 13.5 | 9.0 |
| Homo-PP | | | | | | |
| Profax 6301 Homo-PP | 6.6 | 5.9 | 5.9 | 5.9 | 5.9 | 10.9 |
| LUMICENE | 0.0 | 0.0 | 0.0 | 0.0 | 0.0 | 0.0 |
| MR60MC2 RACO-PP | | | | | | |
| Stannous Chloride | 0.3 | 0.2 | 0.2 | 0.2 | 0.2 | 0.2 |
| dihydrate | | | | | | |
| Phenolic resin | 2.1 | 1.6 | 1.6 | 1.6 | 1.6 | 1.6 |
| HRJ14247A L#3 | | | | | | |
| Zinc Oxide | 0.6 | 0.5 | 0.5 | 0.5 | 0.5 | 0.5 |
| Stearic Acid | 0.05 | 0.04 | 0.04 | 0.04 | 0.04 | 0.04 |
| OIL CONOPURE | 18.3 | 14.0 | 14.0 | 14.0 | 14.2 | 14.1 |
| 12P L#1 | | | | | | |
| UHMW polysiloxane | 0.0 | 0.0 | 0.0 | 4.0 | 0.0 | 5.0 |
| Siloxane (60000 Cst | 2.0 | 2.0 | 2.0 | 0.0 | 5.0 | 0.0 |
| silicone fluid) | | | | | | |
| Cimbar Talc 903 | 3.8 | 2.9 | 2.9 | 2.9 | 3.0 | 2.9 |
| F#6 | | | | | | |
| Irgastab FS301 FF | 0.1 | 0.1 | 0.1 | 0.1 | 0.1 | 0.1 |
| Cyasorb V-703 UV | 0.5 | 0.5 | 0.5 | 0.5 | 0.5 | 0.5 |
| Stabilizer | | | | | | |
| Chimasorb 119FL | 0.1 | 0.1 | 0.1 | 0.1 | 0.1 | 0.1 |
| ADK Stabilizer A0- | 0.1 | 0.1 | 0.1 | 0.1 | 0.1 | 0.1 |
| 412FS | | | | | | |
| Irganox 1010 | 0.2 | 0.1 | 0.1 | 0.1 | 0.1 | 0.1 |
| Antioxidant | | | | | | |
| Carbon Black | 2.0 | 2.0 | 2.0 | 2.0 | 2.0 | 2.0 |
| Total wt % | 100.0 | 100.0 | 100.0 | 100.0 | 100.0 | 100.0 |

| | DOE-15 | DOE-16 | DOE-18 | DOE-19 |
|---|---|---|---|---|
| EPDM 5469 | 31.4 | 31.4 | 31.9 | 31.9 |
| RTP 2700 S30A | 17.0 | 17.0 | 17.0 | 17.0 |
| (SEBS compound) | | | | |
| Braskem F006EC2 | 4.0 | 4.0 | 0.0 | 0.0 |
| Homo-PP | | | | |
| Braskem D115A | 0.0 | 0.0 | 0.0 | 0.0 |
| Homo-PP | | | | |
| TOTAL 3927WZ | 0.0 | 0.0 | 0.0 | 0.0 |
| Homo-PP | | | | |
| Profax 6301 Homo-PP | 10.9 | 5.9 | 9.7 | 8.2 |
| LUMICENE | 10.0 | 15.0 | 16.5 | 19.5 |
| MR60MC2 RACO-PP | | | | |
| Stannous Chloride | 0.2 | 0.2 | 0.2 | 0.2 |
| dihydrate | | | | |
| Phenolic resin | 1.6 | 1.6 | 1.7 | 1.7 |
| HRJ14247A L#3 | | | | |
| Zinc Oxide | 0.5 | 0.5 | 0.5 | 0.5 |
| Stearic Acid | 0.04 | 0.04 | 0.04 | 0.04 |
| OIL CONOPURE | 13.8 | 13.8 | 13.7 | 13.7 |
| 12P L#1 | | | | |
| UHMW polysiloxane | 5.0 | 0.0 | 5.0 | 3.5 |
| Siloxane (60000 Cst | 0.0 | 5.0 | 0.0 | 0.0 |
| silicone fluid) | | | | |
| Cimbar Talc 903 | 2.9 | 2.9 | 2.0 | 2.0 |
| F#6 | | | | |
| Irgastab FS301 FF | 0.1 | 0.1 | 0.1 | 0.1 |
| Cyasorb V-703 UV | 0.5 | 0.5 | 0.3 | 0.3 |
| Stabilizer | | | | |
| Chimasorb 119FL | 0.1 | 0.1 | 0.1 | 0.1 |
| ADK Stabilizer A0- | 0.1 | 0.1 | 0.1 | 0.1 |
| 412FS | | | | |
| Irganox 1010 | 0.1 | 0.1 | 0.1 | 0.1 |
| Antioxidant | | | | |
| Carbon Black | 2.0 | 2.0 | 1.2 | 1.2 |
| Total wt % | 100.0 | 100.0 | 100.0 | 100.0 |

TABLE 3
Peroxide Trexprene A80 SBW-EBHF TPV-CMC Formulations

| | DOE- | DOE- | DOE- | DOE- | DOE- | DOE- |
|---|---|---|---|---|---|---|
| | 6 | 7 | 13 | 14 | 17 | 21 |
| EPDM 5469 | 41.9 | 31.3 | 31.3 | 31.3 | 30.7 | 30.7 |
| RTP 2700 S30A | 0.0 | 20.0 | 17.0 | 17.0 | 17.0 | 17.0 |
| (SEBS compound) | | | | | | |
| Braskem D115A | 17.0 | 16.0 | 16.0 | 16.0 | 9.3 | 0.0 |
| Homo-PP | | | | | | |
| BRASKEM H-521 | 12.4 | 10.2 | 10.2 | 10.2 | 5.8 | 4.3 |
| Homo-PP | | | | | | |
| LUMICENE | 0.0 | 0.0 | 0.0 | 0.0 | 12.0 | 24.3 |
| MR60MC2 RACO-PP | | | | | | |
| DHBP Peroxide | 0.2 | 0.1 | 0.1 | 0.1 | 0.1 | 0.1 |
| TMPTMA | 0.4 | 0.3 | 0.3 | 0.3 | 0.3 | 0.3 |
| PARALUX 6001 | 20.6 | 15.4 | 15.4 | 15.4 | 15.1 | 15.1 |
| PROCESS OIL | | | | | | |
| UHMW Siloxane | 0.0 | 0.0 | 0.0 | 5.0 | 5.0 | 0.0 |
| Siloxane (60000 | 2.0 | 2.0 | 5.0 | 0.0 | 0.0 | 3.5 |
| Cst silicone fluid) | | | | | | |
| MV603 Talc | 3.0 | 2.2 | 2.2 | 2.2 | 2.2 | 2.1 |
| (CIMTUF 9130) | | | | | | |
| Cyasorb V-703 UV | 0.3 | 0.3 | 0.3 | 0.3 | 0.3 | 0.3 |
| Stabilizer | | | | | | |
| ADK Stabilizer | 0.1 | 0.1 | 0.1 | 0.1 | 0.1 | 0.1 |
| AO-412FS | | | | | | |
| Chimasorb 119FL | 0.1 | 0.1 | 0.1 | 0.1 | 0.1 | 0.1 |
| Irganox 1010 | 0.1 | 0.1 | 0.1 | 0.1 | 0.1 | 0.1 |
| Antioxidant | | | | | | |
| Black Pigment | 2.0 | 2.0 | 2.0 | 2.0 | 2.0 | 2.0 |
| Total wt % | 100.0 | 100.0 | 100.0 | 100.0 | 100.0 | 100.0 |

TABLE 4
Mechanical Properties of Phenolic TPV-CMC, Peroxide
TPV-CMC, and Commercial TPV Corner Molding Grade

| | Corner Molding Compound | | | | | |
|---|---|---|---|---|---|---|
| Material | Commercial | Phenolic | | | | |
| Property | TPV | DOE-3 | DOE-4 | DOE-9 | DOE-10 | DOE-11 |
| Viscosity (Pa · s) | 150.59 | 221.1 | 181.1 | 160.05 | 161.1 | 149.52 |
| @ 200° C./204 s⁻¹ | | | | | | |
| (ISO 1133) | | | | | | |
| Melt Flow Rate | 29.2 | 4.1 (5 kg) | 2.9 | 13.92 | | 19.98 |
| (g/10 min) | | | | | | |
| @ 230° C., 21N | | | | | | |
| Hardness | 76.8 | 84.2 | 80.6 | 79.4 | 79.8 | 78 |
| (Shore A) | | | | | | |
| 15 s delay | | | | | | |
| (ISO 868) | | | | | | |
| Density (g/cc) | 0.89 | 0.93 | 0.92 | 0.91 | 0.91 | 0.92 |
| (ISO 1183) | | | | | | |
| Tensile Strength | 7.6 | 9.5 | 10.1 | 9.2 | 9.02 | 8.3 |
| @ Break (MPa) | | | | | | |
| (ISO 37) | | | | | | |
| Modulus @ | 3.2 | 4.4 | 3.9 | 3.6 | 3.7 | 3.5 |
| 100% (MPa) | | | | | | |
| (ISO 37) | | | | | | |
| Elongation @ | 668 | 580 | 694 | 662 | 646 | 632 |
| Break (%) | | | | | | |
| (ISO 37) | | | | | | |
| Tear Strength | 32.9 | 33.8 | 33.3 | 30.6 | 31.4 | 28.4 |
| (kN/m) | | | | | | |
| (ISO 34) | | | | | | |
| Compression Set | 55.8 | 43.6 | 46.2 | 41.8 | 40.2 | 44.6 |
| (22 h @ 70° C.) | | | | | | |
| (ISO 815) | | | | | | |

| | Corner Molding Compound | | | |
|---|---|---|---|---|
| Material | Phenolic | | | |
| Property | DOE-15 | DOE-16 | DOE-18 | DOE-19 |
| Viscosity (Pa · s) | 145.3 | 138.9 | 170 | 185 |
| @ 200° C./204 s⁻¹ | | | | |
| (ISO 1133) | | | | |
| Melt Flow Rate | 13.4 | 22.5 | | |
| (g/10 min) | | | | |
| @ 230° C., 21N | | | | |
| Hardness | 75 | 75.6 | 78 | 79.6 |
| (Shore A) | | | | |
| 15 s delay | | | | |
| (ISO 868) | | | | |
| Density (g/cc) | 0.92 | 0.92 | 0.91 | 0.91 |
| (ISO 1183) | | | | |
| Tensile Strength | 7.9 | 9.1 | 7.8 | 7.3 |
| @ Break (MPa) | | | | |
| (ISO 37) | | | | |
| Modulus @ | 3.58 | 3.5 | 3.5 | 3.24 |
| 100% (MPa) | | | | |
| (ISO 37) | | | | |
| Elongation @ | 592 | 664 | 680 | 720 |
| Break (%) | | | | |
| (ISO 37) | | | | |
| Tear Strength | 34.3 | 33.7 | 34.1 | 34.9 |
| (kN/m) | | | | |
| (ISO 34) | | | | |
| Compression Set | 41.7 | 38.9 | 43.3 | 49.5 |
| (22 h @ 70° C.) | | | | |
| (ISO 815) | | | | |

| | Corner Molding Compound | | | | | |
|---|---|---|---|---|---|---|
| Material | Peroxide | | | | | |
| Property | DOE-6 | DOE-7 | DOE-13 | DOE-14 | DOE-17 | DOE-21 |
| Viscosity (Pa · s) | 148.5 | 136.4 | 116.8 | 133.73 | 99.5 | 90.91 |
| @ 200° C./200 s⁻¹ | | | | | | |
| (ISO 1133) | | | | | | |
| Melt Flow Rate | 2.6 | 16.9 | 39.36 | 25.5 | 64.4 | |
| (g/10 min) | | | | | | |
| @ 230° C., 21N | | | | | | |
| Hardness | 83 | 81 | 81 | 82 | 75 | 78 |
| (Shore A) | | | | | | |
| 15 s delay | | | | | | |
| (ISO 868) | | | | | | |
| Density (g/cc) | 0.91 | 0.91 | 0.89 | 0.91 | 0.91 | 0.92 |
| (ISO 1183) | | | | | | |
| Tensile Strength | 6.7 | 8.3 | 7.5 | 7.4 | 6.95 | 7.9 |
| @ Break (MPa) | | | | | | |
| (ISO 37) | | | | | | |
| Modulus @ | 4.1 | 3.8 | 3.7 | 3.9 | 3.5 | 3.8 |
| 100% (MPa) | | | | | | |
| (ISO 37) | | | | | | |
| Elongation @ | 656 | 736 | 744 | 668 | 698 | 654 |
| Break (%) | | | | | | |
| (ISO 37) | | | | | | |
| Tear Strength | 33.3 | 32.7 | 32 | 33.8 | 35.7 | 35.9 |
| (kN/m) | | | | | | |
| (ISO 34) | | | | | | |
| Compression Set | 50.5 | 46.2 | 55.6 | 51.7 | 58 | |
| (22 h @ 70° C.) | | | | | | |
| (ISO 815) | | | | | | |

In addition to mechanical properties, the bondability of TPV-CMC with GRC profile is considered one of the key performance attributes. A good bonding is essential between the GRC extrusion profile and TPV-CMC to eliminate split issues. FIGS. 5A and 6A show a schematic illustration of polymer chain diffusion process across the interface between injection molded GRC plaque and TPV-CMC. Injection molding parameters such as melt temperature, injection pressure, mold temperature, and injection speed all have an impact on adhesion strength and elongation. This is because higher melt and/or mold temperature, higher injection speed, and higher injection pressure will ensure complete melting of thermoplastic phase (PP) in GRC profile and promote polymer chain diffusion across the interface, which results in an excellent mechanical interlocking between TPV-CMC and GRC profile. In the case when vulcanized EPDM is used as a GRC profile, different mechanisms might prevail due to the absence of a PP phase. The adhesion strength and elongation were measured on the bonded specimen in accordance with ISO 37 standard at 200 mm/min extension rate. The bonded specimens 16 were cut from the molded shapes as shown in FIGS. 5B and 6C.

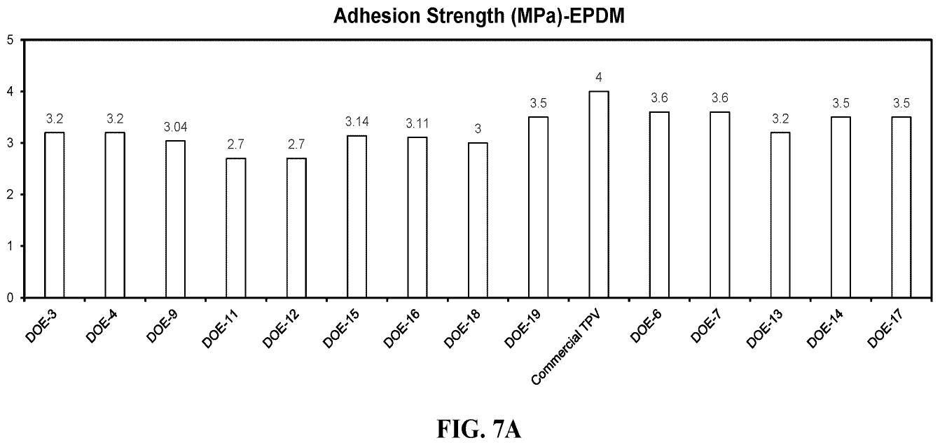

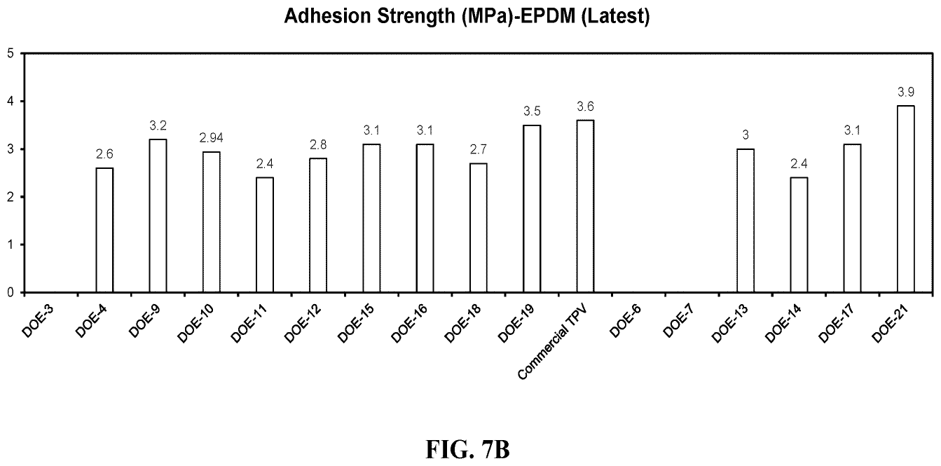

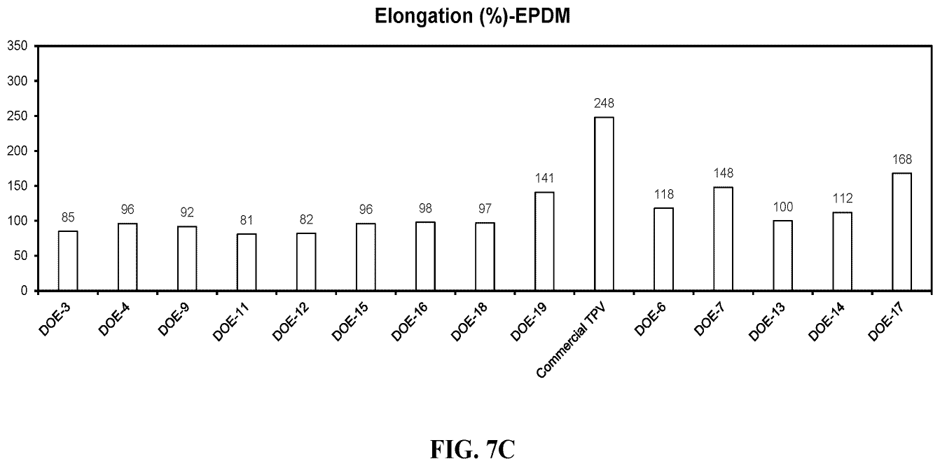

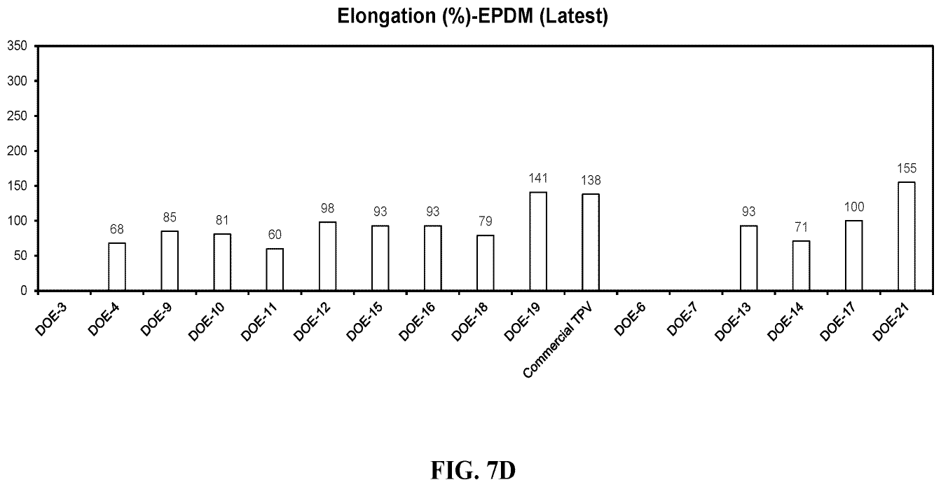

FIGS. 7A-D, 8A-B, and 9A-B illustrate the adhesion strength (also termed fusion strength) and elongation at break properties of TPV-CMC adhered with vulcanized EPDM GRC plaque, Santoprene 101-64, or Trexprene A67BW-LF. The results tabulated are the average of 6 samples. For the adhesion, the injection over molding process was performed at a melt temperature of 260° C., injection speed of 0.05-0.1 m/s, and mold temperature of 65° C. These samples were produced from either the first configuration of FIGS. 5A and 5B or the second configuration of FIGS. 6A-C, which are different geometries of the TPV corner molding compound 10 and TPV or EPDM GRC 12.

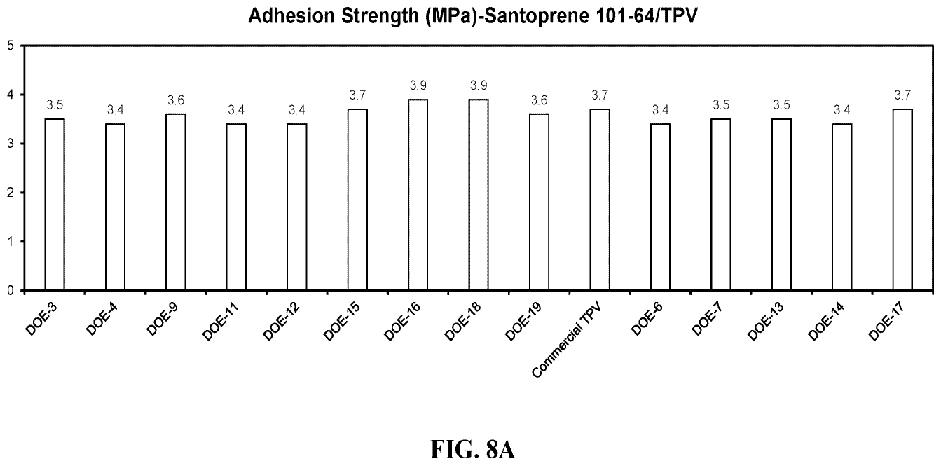

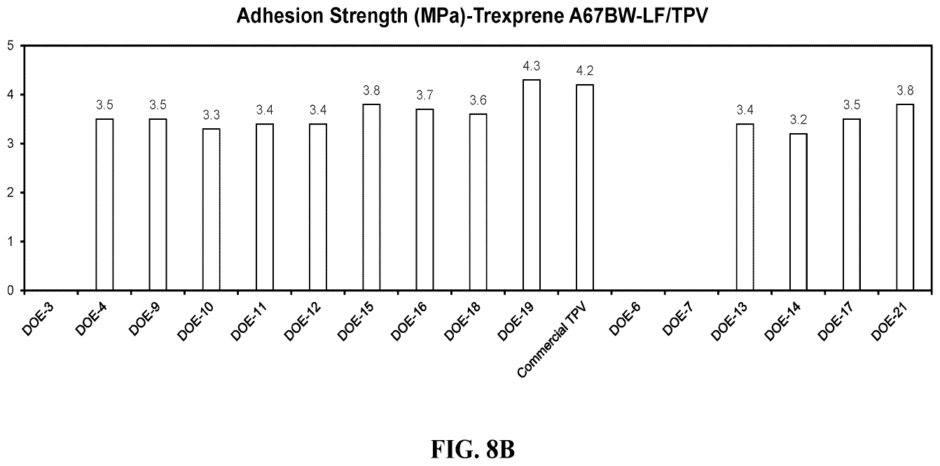

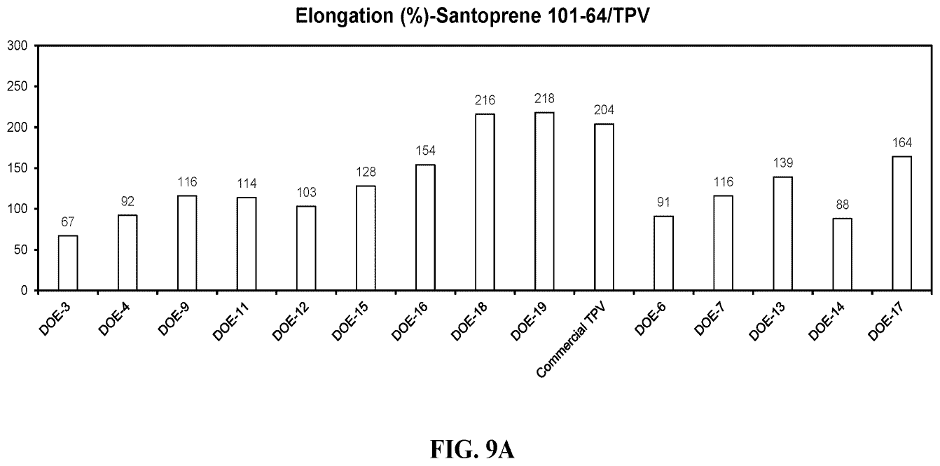

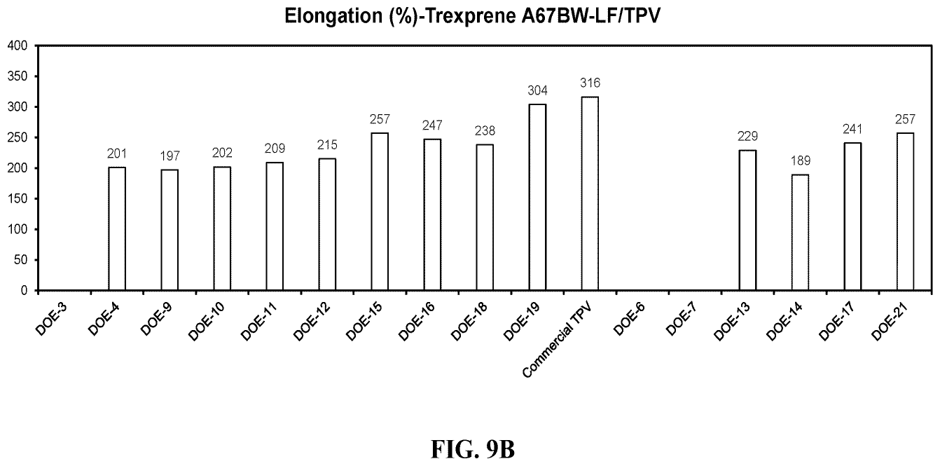

The EPDM adhesion results in FIGS. 7A and 7C, and the Santoprene 101-64 results in FIGS. 8A and 9A, were produced using the first configuration as shown in FIGS. 5A and 5B. The EPDM adhesion results in FIGS. 7B and 7D, and the Trexprene A67BW-LF results in FIGS. 8A and 9A, were produced using the second configuration as shown in FIGS. 6A-C.

### Vulcanized EPDM

Due to the absence of thermoplastic PP phase in vulcanized EPDM GRC, we presume that the adhesion mechanism between TPV-CMC and vulcanized EPDM GRC is different. As shown in FIGS. 7A and 7C, peroxide TPV-CMC has a comparatively higher adhesion strength and elongation compared to phenolic TPV-CMC. However, addition of SEBS (DOE #4&7) and silicone loading level of 5 wt % (DOE #11&13) followed a similar trend in increase and decrease of adhesion strength and elongation properties in both phenolic and peroxide cured TPV-CMC, respectively. As shown, RACO-PP addition has an effect on adhesion strength and elongation (DOE #15&17), while RACO-PP content has almost no impact on performance.

### Santoprene 101-64

Santoprene 101-64 is a TPV having finely dispersed particles of vulcanized EPDM in a thermoplastic PP matrix phase. As described in an earlier section, TPV-CMC melts the PP phase in the GRC plaque, which initiates a polymer chain diffusion process to occur across the interface between the injection molded GRC plaque and the TPV-CMC. The material properties of TPV-CMC such as viscosity and percent crystallinity have a significant impact on adhesion strength and elongation value. As shown in FIGS. 8A and 9A, addition of SEBS increases elongation in both phenolic and peroxide cured TPV-CMC (DOE #4&7, respectively). This is because of reduction in viscosity and percent crystallinity as illustrated in Tables 4&5, respectively. The improved flow property in DOE #9 due to high flow PP homopolymer (60 MFR) also resulted in improved adhesion strength and elongation. Increasing silicone loading level to 5 wt % in DOE #11 lowered adhesion strength and elongation compared to DOE #9, where the silicone loading is at 2 wt %. However, a stark contrast is observed in the case of peroxide cured TPV-CMC (DOE #7 &13). This is because DOE #13 had a significant drop in viscosity and percent crystallinity compared to DOE #7. The introduction of RACO-PP (60 MFR) (DOE #15&17) has an impact on reducing viscosity and the crystallinity of TPV-CMC, which resulted in an improvement in adhesion strength and elongation. Similarly, as we increase the content of RACO-PP in TPV-CMC (DOE #15, 16 & 18) viscosity and crystallinity decreases which explains the reason for observed adhesion strength and elongation values as shown in FIGS. 8A and 9A.

### Trexprene A67BW-LF

Trexprene A67BW-LF followed similar trends as Santoprene 101-64

TABLE 5
Percentage Crystallinity Based on Heat of Fusion (J/g) as
Determined using Differential Scanning Calorimeter (DSC)

| DOE# | % Crystallinity |
|---|---|
| 3 | 16 |
| 4 | 14.2 |
| 9 | 12.8 |
| 10 | 13.3 |
| 11 | 13.0 |
| 12 | 14.2 |
| 15 | 11.7 |
| 16 | 10.9 |
| 18 | 10.7 |
| 19 | 8.6 |
| 6 | 16.6 |
| 7 | 15.6 |
| 13 | 13.7 |
| 14 | 14.3 |
| 17 | 12.2 |
| 21 | 13.5 |

In addition to measuring adhesion strength, a first creep experiment was performed at 100° C. using 370 g load for a duration over 24 h (precisely 168 h) using the experimental setup as shown in FIG. 10. As explained earlier, this test predicts split issue or the lack of adhesion which might occur between GRC profile and TPV-CMC. Table 6 below shows the results from this creep experiment; both phenolic and peroxide TPV-CMC demonstrate good bonding to GRC profiles for an extended period of 168 h. The sturdiness rating of 10 indicates no failure or split occurred during first 24 h time interval. This performance ensures split-proof butt-joints during service life, and the results are comparable to the commercial TPV corner molding grade.

TABLE 6
Creep Performance of Phenolic TPV-CMC, Peroxide TPV-CMC and Commercial
TPV Corner Molding Grades with GRC Profiles of Santoprene and EPDM

| | Phenolic | | | | | | | | | |
|---|---|---|---|---|---|---|---|---|---|---|
| GRC Profile | DOE-3 | DOE-4 | DOE-9 | DOE-10 | DOE 11 | DOE 12 | DOE 15 | DOE 16 | DOE-18 | DOE-19 |
| Santoprene 101-64 | 10 | 10 | 10 | 10 | 10 | 10 | 10 | 10 | 10 | 10 |
| EPDM | 10 | 10 | 10 | 10 | 10 | 10 | 10 | 10 | 10 | 10 |

| | Commercial | Peroxide | | | | | |
|---|---|---|---|---|---|---|---|
| GRC Profile | TPV | DOE-6 | DOE-7 | DOE-13 | DOE-14 | DOE-17 | DOE-21 |
| Santoprene 101-64 | 10 | 10 | 10 | 10 | 10 | 10 | 10 |
| EPDM | 10 | 10 | 10 | 10 | 10 | 10 | 10 |

Additional creep experiments were performed with loads of 370 g, but at temperatures of 90° C. and with the specimens bent at a 90° angle. The experimental setup is shown in FIGS. 11A-B. Dumbbell shaped test pieces 16 according to ISO 37 Type 1 were cut from adhesion plaques similar to FIG. 6C. Table 7 shows the results for three samples each of DOE-19, 17, 21, and commercial TPV bonded to EPDM 85265 monitored over a period of 13 days. The majority of the samples of DOE-19 and 17 broke, but none of the samples of DOE-21 broke over these conditions.

Table 8 shows results of additional creep tests using loads of 370 g with a 90° angle bend in the specimen and environmental conditions of 90° C., similar to the results in

Table 7. Here, certain inventive TPV samples were formed with adhesions to two each of TPV GRC and EPDM GRC. The samples under strain were monitored for 2 weeks, and the number of hours that it took for a sample to break is indicated on the table. Where “NB” is listed, there was “no break” for the entire testing period.

Table 9 shows additional creep test results that compared three samples each of DOE-21 and commercial TPV, bonded to EPDM 85265. The numbers show what percentage of the three samples have broken at the indicated time. Again, ISO 37 Type 1 dumbbell shaped specimens were stressed with 370 g weights, bent at a 90° angle, and maintained at a 90° C. temperature. Up to 14 days, no sample broke. However, up to 35 days, 67% of the commercial TPV specimens broke, while none of the DOE-21 specimens broke. It is seen here that the DOE-21 shows superior adhesion strength to EPDM 85265 under conditions of high strain and high temperature.

TABLE 7
Creep Performance of Phenolic TPV-CMC, Peroxide TPV-
CMC, and Commercial TPV Corner Molding Grades with
GRC Profiles of EPDM at 90° angle and 90°
C. temperature: Number Out of Three Samples Broken Over Time

| Hybrid Specimens | | 12 | 24 | 30 | 48 | 56 | 72 | 6 | 13 |
|---|---|---|---|---|---|---|---|---|---|
| Injection | Extrusion | h | h | h | h | h | h | d | d |
| DOE-19 | EPDM 85265 strip | 0 | 1 | 1 | 1 | 1 | 2 | 3 | 3 |
| DOE-17 | EPDM 85265 strip | 0 | 0 | 0 | 0 | 0 | 0 | 1 | 2 |
| DOE-21 | EPDM 85265 strip | 0 | 0 | 0 | 0 | 0 | 0 | 0 | 0 |
| Commercial | EPDM 85265 strip | 0 | 0 | 0 | 0 | 0 | 0 | 0 | 0 |
| TPV | | | | | | | | | |

TABLE 8
90° Angle Bend Creep Testing at 90° C. and
370 g Center Line Load for 2 Weeks (336 h).

| | GRC Material | |
|---|---|---|
| Sample | TPV | EPDM |

| | | | | | |
|---|---|---|---|---|---|
| Phenolic | DOE-4 | NB | NB | NB | NB |
| | DOE-10 | NB | NB | NB | NB |
| | DOE-15 | NB | NB | NE | 191 h |
| | DOE-16 | NB | NB | NB | NB |
| | DOE-19 | NB | NB | NB | NB |
| Peroxide | DOE-17 | NB | 254 h | 86 h | NB |
| | DOE-21 | NB | NB | NB | NB |

| | | | | |
|---|---|---|---|---|
| Commercial TPV | NB | NB | NB | NB |

TABLE 9
Creep Performance of Peroxide TPV-CMC DOE-21 and
Commercial TPV Corner Molding Grades with GRC Profiles
of EPDM at 90° angle and 90° C. temperature:
Percentage out of Three Samples Broken Over Time

| Hybrid Specimens | | 12 | 24 | 30 | 48 | 56 | 72 |
|---|---|---|---|---|---|---|---|
| Injection | Extrusion | h | h | h | h | h | h |
| DOE-21 | EPDM 85265 strip | 0% | 0% | 0% | 0% | 0% | 0% |
| Commercial | EPDM 85265 strip | 0% | 0% | 0% | 0% | 0% | 0% |
| TPV | | | | | | | |

| Hybrid Specimens | | 7 | 14 | 21 | 23 | 28 | 35 |
|---|---|---|---|---|---|---|---|
| Injection | Extrusion | d | d | d | d | d | d |
| DOE-21 | EPDM 85265 strip | 0% | 0% | 0% | 0% | 0% | 0% |
| Commercial | EPDM 85265 strip | 0% | 0% | 33% | 33% | 67% | 67% |
| TPV | | | | | | | |

Another key performance attribute for corner molding application is the co-efficient of friction (COF). FIG. 12 illustrates the schematic of a test apparatus used to measure static and kinetic COF, and the results are shown in Table 10. As seen, both static (μₛ) and kinetic (μ_{D}) COF values decrease with the increase in silicone loading level to 5 wt % in DOE #11. The static and kinetic COF for all TPV-CMC (phenolic and peroxide) is comparable and even better (DOE #16&17) than commercial TPV corner molding grade, implying a similar or superior tribological performance when used in contact with a glass surface.

TABLE 10
Static (μₛ) and kinetic (μ_{D}) COF of Phenolic
TPV-CMC, Peroxide TPV-CMC, and Commercial TPV TPV
Corner Molding Grade measured against a glass surface.

| | μ_{S} Static COF | μ_{D} Dynamic COF |
|---|---|---|
| 3 | 0.55 | 0.54 |
| 4 | 0.21 | 0.18 |
| 9 | 0.43 | 0.42 |
| 10 | 0.32 | 0.30 |
| 11 | 0.33 | 0.31 |
| 12 | 0.27 | 0.24 |
| 15 | 0.30 | 0.27 |
| 16 | 0.28 | 0.22 |
| 18 | 0.31 | 0.29 |
| 19 | 0.25 | 0.23 |
| 6 | 0.35 | 0.32 |
| 7 | 0.30 | 0.27 |
| 13 | 0.3 | 0.26 |
| 14 | 0.29 | 0.26 |
| 17 | 0.28 | 0.20 |
| 21 | 0.26 | 0.21 |

The following are exemplary embodiments of the disclosure:

Embodiment 1. A composition for a thermoplastic vulcanizate, comprising:
12-25 wt % ethylene propylene diene rubber;
12-25 wt % styrenic thermoplastic elastomer;
8-30 wt % thermoplastic polyolefin;
0.01-3.0 wt % phenolic resin;
5-40 wt % process oil;
1-10 wt % slip additive; and
0.5-8 wt % inorganic filler;
each weight percent relative to a total weight of the composition.

Embodiment 2. The composition of Embodiment 1, wherein the thermoplastic polyolefin is a polypropylene-based resin.

Embodiment 3. The composition of Embodiment 1 or 2, wherein the thermoplastic polyolefin comprises a random copolymer of polypropylene and a homopolymer of polypropylene.

Embodiment 4. The composition of Embodiment 3, wherein the random copolymer of polypropylene has a density in a range of 0.90-0.95 g/cm³.

Embodiment 5. The composition of any one of Embodiments 1 to 4, further comprising 0.01-2.0 wt % stannous chloride and 0.1-1.0 wt % zinc oxide.

Embodiment 6. The composition of any one of Embodiments 1 to 5, wherein the composition comprises 16-22 wt % of the styrenic thermoplastic elastomer.

Embodiment 7. The composition of any one of Embodiments 1 to 6, wherein the slip additive comprises a polysiloxane having a weight average molecular weight of at least 700,000 g/mol.

Embodiment 8. The composition of any one of Embodiments 1 to 7, wherein the inorganic filler comprises talc.

Embodiment 9. The composition of any one of Embodiments 1 to 8, further comprising 0.5-10 wt % polyhedral oligomeric silsesquioxane.

Embodiment 10. A thermoplastic vulcanizate, made by dynamically vulcanizing the composition of any one of Embodiments 1 to 9.

Embodiment 11. The thermoplastic vulcanizate of Embodiment 10, which has a crystallinity of less than 15% as measured by DSC.

Embodiment 12. The thermoplastic vulcanizate of Embodiments 10 or 11, wherein after aging at 100-150° C. for 750-1,250 h has a tensile strength that is decreased by 12% or less as compared to a tensile strength before the aging.

Embodiment 13. The thermoplastic vulcanizate of any one of Embodiments 10 to 12, wherein after aging at 100-150° C. for 750-1,250 h has an elongation at break that is decreased by 20% or less as compared to an elongation at break before the aging.

Embodiment 14. The thermoplastic vulcanizate of any one of Embodiments 10 to 13, having a static coefficient of friction in a range of 0.20-0.35 and a kinetic coefficient of friction in a range of 0.20-0.35.

Embodiment 15. A corner molding compound, comprising the thermoplastic vulcanizate of any one of Embodiments 10 to 14.

Embodiment 16. An automotive assembly comprising the corner molding compound of Embodiment 15 adhered to a glass-run channel, the glass-run channel comprising a second thermoplastic vulcanizate at a joint, wherein an adhesion strength measured across the joint is in a range of 3.2-4.5 MPa.

Embodiment 17. An automotive assembly comprising the corner molding compound of Embodiment 15 adhered to a glass-run channel, the glass-run channel comprising a second thermoplastic vulcanizate at a joint, wherein an elongation at break measured across the joint is in a range of 120-275%.

Embodiment 18. An automotive assembly comprising the corner molding compound of Embodiment 15 adhered to a glass-run channel, the glass-run channel comprising a vulcanized EPDM at a joint, wherein an adhesion strength measured across the joint is in a range of 3.2-4.5 MPa.

Embodiment 19. An automotive assembly comprising the corner molding compound of Embodiment 15 adhered to a glass-run channel, the glass-run channel comprising a vulcanized EPDM at a joint, wherein an elongation at break measured across the joint is in a range of 120-275%.

Embodiment 20. A composition for a thermoplastic vulcanizate, comprising:
12-25 wt % ethylene propylene diene rubber;
12-25 wt % styrenic thermoplastic elastomer;
8-30 wt % thermoplastic polyolefin;
0.1-1.5 wt % peroxide crosslinking agent;
5-40 wt % process oil;
1-10 wt % slip additive; and
0.5-8 wt % inorganic tiller; each weight percent relative to a total weight of the composition.

Embodiment 21. The composition of Embodiment 20, wherein the thermoplastic polyolefin is a polypropylene-based resin.

Embodiment 22. The composition of Embodiment 20 or 21, wherein the thermoplastic polyolefin comprises a random copolymer of polypropylene and a homopolymer of polypropylene.

Embodiment 23. The composition of Embodiment 22, wherein the random copolymer of polypropylene has a density in a range of 0.90-0.95 g/cm³.

Embodiment 24. The composition of any one of Embodiments 20 to 23, wherein the peroxide crosslinking agent comprises at least one organic peroxide selected from the group consisting of di-tert-butyl peroxide, dicumyl peroxide, t-butylcumyl peroxide, α,α′-bis(tert-butylperoxy) diisopropyl benzene, 2,5-dimethyl-2,5-di-(tert-butylperoxy)hexane, 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, and 2,5-dimethyl-2,5-di(tert-butylperoxy) hexyne-3.

Embodiment 25. The composition of any one of Embodiments 20 to 24, wherein the peroxide crosslinking agent is 2,5-dimethyl-2,5-di-(tert-butylperoxy)hexane.

Embodiment 26. The composition of any one of Embodiments 20 to 25, wherein the composition comprises 16-22 wt % styrenic thermoplastic elastomer.

Embodiment 27. The composition of any one of Embodiments 20 to 26, wherein the inorganic filler comprises talc.

Embodiment 28. The composition of any one of Embodiments 20 to 27, further comprising 0.5-10 wt % polyhedral oligomeric silsesquioxane.

Embodiment 29. A thermoplastic vulcanizate, made by dynamically vulcanizing the composition of any one of Embodiments 20 to 28.

Embodiment 30. The thermoplastic vulcanizate of Embodiment 29, which has a crystallinity of less than 15% as measured by DSC.

Embodiment 31. The thermoplastic vulcanizate of Embodiment 29 or 30, wherein after aging at 100-125° C. for 750-1,000 h has a tensile strength that is decreased by 16% or less as compared to a tensile strength before the aging.

Embodiment 32. The thermoplastic vulcanizate of any one of Embodiments 29 to 31, wherein after aging at 100-125° C. for 750-1,000 h has an elongation at break that is decreased by 25% or less as compared to an elongation at break before the aging.

Embodiment 33. The thermoplastic vulcanizate of any one of Embodiments 29 to 32, having a static coefficient of friction in a range of 0.20-0.35 and a kinetic coefficient of friction in a range of 0.15-0.30.

Embodiment 34. A corner molding compound, comprising the thermoplastic vulcanizate of any one of Embodiments 29 to 33.

Embodiment 35. An automotive assembly comprising the corner molding compound of Embodiment 34 adhered to a glass-run channel, the glass-run channel comprising a second thermoplastic vulcanizate at a joint, wherein an adhesion strength measured across the joint is in a range of 3.2-4.1 MPa.

Embodiment 36. An automotive assembly comprising the corner molding compound of Embodiment 34 adhered to a glass-run channel, the glass-run channel comprising a second thermoplastic vulcanizate at a joint, wherein an elongation at break measured across the joint is in a range of 120-180%.

Embodiment 37. An automotive assembly comprising the corner molding compound of Embodiment 34 adhered to a glass-run channel, the glass-run channel comprising a vulcanized EPDM at a joint, wherein an adhesion strength measured across the joint is in a range of 3.2-4.1 MPa.

Embodiment 38. An automotive assembly comprising the corner molding compound of Embodiment 34 adhered to a glass-run channel, the glass-run channel comprising a vulcanized EPDM at a joint, wherein an elongation at break measured across the joint is in a range of 120-180%.

Embodiment 39. An automotive assembly comprising the corner molding compound of Embodiment 34 adhered to a glass-run channel, the glass-run channel comprising a vulcanized EPDM at a joint having a cross-section area of no greater than 50 mm² and bent at an angle of 80-100°, wherein the joint does not break for at least 14 days at a temperature of at least 80° C. and under the strain of a weight of at least 300 g.

Embodiment 40. The automotive assembly of Embodiment 39, wherein the joint does not break for at least 35 days.

The headings (such as “Background” and “Summary”) and sub-headings used herein are intended only for general organization of topics within the present invention, and are not intended to limit the disclosure of the present invention or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

As used herein, the term “and/or” includes any and all combinations of one or more of the associated listed items and may be abbreviated as “/”.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, are intended to be non-limiting, such that recitation of items in a list is not to the exclusion of other like items that may also be useful in the materials, compositions, devices, and methods of this technology.

Similarly, the terms “can,” and “may,” and their variants are intended to be non-limiting, such that recitation that an embodiment can or may comprise certain elements or features does not exclude other embodiments of the present invention that do not contain those elements or features.

Although the terms “first,” “second,” and the like may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Spatially relative terms, such as “under,” “below,” “lower,” “over,” “upper,” “in front of,” “behind,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under,” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected,” “attached,” or “coupled” to another feature or element, it can be directly connected, attached or coupled to the other feature or element or intervening features or elements may be present. In contrast, when a feature or element is referred to as being “directly connected,” “directly attached,” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

The description, figures, and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

1. A composition for a thermoplastic vulcanizate, comprising:
12-25 wt % ethylene propylene diene rubber;
12-25 wt % styrenic thermoplastic elastomer;
8-30 wt % thermoplastic polyolefin;
0.01-3.0 wt % phenolic resin;
5-40 wt % process oil;
1-10 wt % slip additive; and
0.5-8 wt % inorganic filler;
10 each weight percent relative to a total weight of the composition.

2. The composition of claim 1, wherein the thermoplastic polyolefin is a polypropylene-based resin.

3. The composition of claim 1, wherein the thermoplastic polyolefin comprises a random copolymer of polypropylene and a homopolymer of polypropylene.

4. The composition of claim 3, wherein the random copolymer of polypropylene has a density in a range of 0.90-0.95 g/cm³.

5. The composition of claim 1, further comprising 0.01-2.0 wt % stannous chloride and 0.1-1.0 wt % zinc oxide.

6. The composition of claim 1, wherein the composition comprises 16-22 wt % of the styrenic thermoplastic elastomer.

7. The composition of claim 1, wherein the slip additive comprises a polysiloxane having a weight average molecular weight of at least 700,000 g/mol.

8. The composition of claim 1, wherein the inorganic filler comprises talc.

9. The composition of claim 1, further comprising 0.5-10 wt % polyhedral oligomeric silsesquioxane.

10. A thermoplastic vulcanizate, made by dynamically vulcanizing the composition of claim 1.

11. The thermoplastic vulcanizate of claim 10, which has a crystallinity of less than 15% as measured by DSC.

12. The thermoplastic vulcanizate of claim 10, wherein after aging at 100-150° C. for 750-1,250 h has a tensile strength that is decreased by 12% or less as compared to a tensile strength before the aging.

13. The thermoplastic vulcanizate of claim 10, wherein after aging at 100-150° C. for 750-1,250 h has an elongation at break that is decreased by 20% or less as compared to an elongation at break before the aging.

14. The thermoplastic vulcanizate of claim 10, having a static coefficient of friction in a range of 0.20-0.35 and a kinetic coefficient of friction in a range of 0.20-0.35.

15. A corner molding compound, comprising the thermoplastic vulcanizate of claim 10.

16. An automotive assembly comprising the corner molding compound of claim 15 adhered to a glass-run channel, the glass-run channel comprising a second thermoplastic vulcanizate at a joint, wherein an adhesion strength measured across the joint is in a range of 3.2-4.5 MPa.

17. An automotive assembly comprising the corner molding compound of claim 15 adhered to a glass-run channel, the glass-run channel comprising a second thermoplastic vulcanizate at a joint, wherein an elongation at break measured across the joint is in a range of 120-275%.

18. An automotive assembly comprising the corner molding compound of claim 15 adhered to a glass-run channel, the glass-run channel comprising a vulcanized EPDM at a joint, wherein an adhesion strength measured across the joint is in a range of 3.2-4.5 MPa.

19. An automotive assembly comprising the corner molding compound of claim 15 adhered to a glass-run channel, the glass-run channel comprising a vulcanized EPDM at a joint, wherein an elongation at break measured across the joint is in a range of 120-275%.

20. A composition for a thermoplastic vulcanizate, comprising:
12-25 wt % ethylene propylene diene rubber;
12-25 wt % styrenic thermoplastic elastomer;
8-30 wt % thermoplastic polyolefin;
0.1-1.5 wt % peroxide crosslinking agent;
5-40 wt % process oil;
1-10 wt % slip additive; and
0.5-8 wt % inorganic filler;
each weight percent relative to a total weight of the composition.

21. The composition of claim 20, wherein the thermoplastic polyolefin is a polypropylene-based resin.

22. The composition of claim 20, wherein the thermoplastic polyolefin comprises a random copolymer of polypropylene and a homopolymer of polypropylene.

23. The composition of claim 22, wherein the random copolymer of polypropylene has a density in a range of 0.90-0.95 g/cm³.

24. The composition of claim 20, wherein the peroxide crosslinking agent comprises at least one organic peroxide selected from the group consisting of di-tert-butyl peroxide, dicumyl peroxide, t-butylcumyl peroxide, α,α′-bis(tert-butylperoxy) diisopropyl benzene, 2,5-dimethyl-2,5-di-(tert-butylperoxy)hexane, 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, and 2,5-dimethyl-2,5-di(tert- butylperoxy) hexyne-3.

25. The composition of claim 20, wherein the peroxide crosslinking agent is 2,5-dimethyl-2,5-di-(tert-butylperoxy)hexane.

26. The composition of claim 20, wherein the composition comprises 16-22 wt % styrenic thermoplastic elastomer.

27. The composition of claim 20, wherein the inorganic filler comprises talc.

28. The composition of claim 20, further comprising 0.5-10 wt % polyhedral oligomeric silsesquioxane.

29. A thermoplastic vulcanizate, made by dynamically vulcanizing the composition of claim 20.

30. The thermoplastic vulcanizate of claim 29, which has a crystallinity of less than 15% as measured by DSC.

31. The thermoplastic vulcanizate of claim 29, wherein after aging at 100-125° C. for 750-1,000 h has a tensile strength that is decreased by 16% or less as compared to a tensile strength before the aging.

32. The thermoplastic vulcanizate of claim 29, wherein after aging at 100-125° C. for 750-1,000 h has an elongation at break that is decreased by 25% or less as compared to an elongation at break before the aging.

33. The thermoplastic vulcanizate of claim 29, having a static coefficient of friction in a range of 0.20-0.35 and a kinetic coefficient of friction in a range of 0.15-0.30.

34. A corner molding compound, comprising the thermoplastic vulcanizate of claim 29.

35. An automotive assembly comprising the corner molding compound of claim 34 adhered to a glass-run channel, the glass-run channel comprising a second thermoplastic vulcanizate at a joint, wherein an adhesion strength measured across the joint is in a range of 3.2-4.1 MPa.

36. An automotive assembly comprising the corner molding compound of claim 34 adhered to a glass-run channel, the glass-run channel comprising a second thermoplastic vulcanizate at a joint, wherein an elongation at break measured across the joint is in a range of 120-180%.

37. An automotive assembly comprising the corner molding compound of claim 34 adhered to a glass-run channel, the glass-run channel comprising a vulcanized EPDM at a joint, wherein an adhesion strength measured across the joint is in a range of 3.2-4.1 MPa.

38. An automotive assembly comprising the corner molding compound of claim 34 adhered to a glass-run channel, the glass-run channel comprising a vulcanized EPDM at a joint, wherein an elongation at break measured across the joint is in a range of 120-180%.

39. An automotive assembly comprising the corner molding compound of claim 34 adhered to a glass-run channel, the glass-run channel comprising a vulcanized EPDM at a joint having a cross-section area of no greater than 50 mm² and bent at an angle of 80-100°, wherein the joint does not break for at least 14 days at a temperature of at least 80° C. and under the strain of a weight of at least 300 g.

40. The automotive assembly of claim 39, wherein the joint does not break for at least 35 days.
